(19) United States
(12) Patent Application Publication
(10) Pub. No.: US 2008/0046836 A1
(43) Pub. Date: Feb. 21, 2008

(54) Method and apparatus for selecting scroll condtion of displayed screen

(75) Inventors: Kiyoko Maruyama, Kanagawa-ken (JP); Seiji Matsui, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/724,565

(22) Filed: Mar. 15, 2007

(30) Foreign Application Priority Data
Aug. 18, 2006 (JP) 2006-223174

(51) Int. Cl. G06F 3/048

(52) U.S. Cl. 715/784

(57) ABSTRACT

A data processing apparatus capable of detecting an object being in contact with a portion thereof is provided. The data processing apparatus includes a display, a tactile sensor and a controller. The tactile sensor is configured to detect the object and to locate the object on a sensing surface thereof. The controller is coupled to the display and the tactile sensor, configured to locate an initial location of the object on the sensing surface if the object starts being detected, and configured to locate a final location of the object on the sensing surface if the object ends being detected. The controller is configured to select a scroll direction depending on a direction from the initial location to the final location. The controller is configured to select a scroll speed, and configured to scroll a screen displayed on the display in the scroll direction at the scroll speed.

### CROSS REFERENCE TO RELATED APPLICATIONS

This application is based upon and claims the benefit of priority from the prior Japanese Patent Application No. 2006-223174 filed on Aug. 18, 2006; the entire contents of which are incorporated herein by reference.

### FIELD OF THE INVENTION

The present invention relates to a method and an apparatus for selecting a scroll condition of a displayed screen, and in particular to those for data processing.

### DESCRIPTION OF THE BACKGROUND

For scrolling a screen shown on a display of a data processing apparatus like a mobile phone, a personal digital assistant (PDA) or a personal computer, known is a method in recent years by using a scrollbar and scroll arrows (two-way arrowheads at both ends of the scrollbar) presented on the display.

If the data processing apparatus has a display combined with a tactile sensor formed by highly integrated pressure sensors and so on, there are other methods for scrolling the screen according to a move of an object (e.g., a finger, a pen for a graphics tablet, i.e., a stylus) on the tactile sensor.

A first one of the above methods is disclosed in Japanese Patent Publication (Kokai), No. 2003-330613, applicable to a data processing apparatus which has an LCD panel serving as a display device layered with a transparent touch panel serving as an input device. If a stylus is moved or dragged on the LCD panel, a menu screen shown on the LCD panel may be scrolled according to a moving speed of the stylus.

A second one of the above methods is disclosed in Japanese Patent Publication (Kokai), No. 2004-287640, applicable to a data processing apparatus which has a panel uniformly spaced from a surface of a display device and supported by a plurality of pressure sensors placed in between. The data processing apparatus may detect pressure on each of the pressure sensors, may determine where an object is detected on the panel, and may determine how much pressure is applied. Based on a result of the above determination, the data processing apparatus may scroll a screen shown on the display device.

A third one of the above methods is disclosed in Japanese Patent Publication (Kokai), No. 2002-333951, applicable to a data processing apparatus which has one-dimensional tactile sensors vertically and horizontally placed on a display. The data processing apparatus may sequentially detect a finger on each of the tactile sensors and may determine coordinates of the finger. The data processing apparatus may select a scroll speed on the display based on the coordinates of the finger. The data processing apparatus may thereby scroll a screen vertically and horizontally on the display at a speed determined by a moving speed of the finger.

By the above methods, the data processing apparatus having a tactile sensor may determine a scroll speed and a scroll direction, and may scroll a screen on the display according to the determined scroll speed and scroll direction. A small sized data processing apparatus like a mobile phone, however, may assign limited space to a tactile sensor. If one of the above methods is applied to the small sized data processing apparatus, repetitive touch and move operation of an object on the tactile sensor may be required for scrolling as desired on the display, which could be time-consuming.

### SUMMARY OF THE INVENTION

Accordingly, an advantage of the present invention is that a data processing apparatus may enable quick and easy selection of a preferred scroll condition despite of a limited resource of the data processing apparatus.

To achieve the above advantage, one aspect of the present invention is to provide a data processing apparatus capable of detecting an object being in contact with a portion of the data processing apparatus. The data processing apparatus includes a display configured to display a screen and a tactile sensor having a sensing surface. The tactile sensor is configured to detect the object and configured to locate the object on the sensing surface. The data processing apparatus includes a controller coupled to the display and the tactile sensor. The controller is configured to locate an initial location of the object on the sensing surface if the object starts being detected, and configured to locate a final location of the object on the sensing surface if the object ends being detected. The controller is configured to select a scroll direction depending on a direction from the initial location to the final location. The controller is configured to select a scroll speed, and configured to scroll the screen on the display in the scroll direction at the scroll speed.

### BRIEF DESCRIPTION OF THE DRAWINGS

FIG. 1 is an external view of a data processing apparatus of an embodiment (a mobile phone) of the present invention in an open configuration.

FIG. 2 is an external view of the mobile phone in a closed configuration.

FIG. 3 is a block diagram of the mobile phone.

FIG. 4 shows a concept of a first method for selecting a scroll condition applicable to the mobile phone of the embodiment of the present invention.

FIG. 5 is a functional block diagram of the mobile phone to illustrate the first method.

FIG. 6 is a flow chart of the first method.

FIG. 7 illustrates sequential detection of an object at coordinates on a tactile sensor of the mobile phone according to the first method.

FIG. 8 shows a concept of a second method for selecting a scroll condition applicable to the mobile phone of the embodiment of the present invention.

FIG. 9 is a functional block diagram of the mobile phone to illustrate the second method.

FIG. 10 is a flow chart of the second method.

FIG. 11 illustrates sequential detection of an object at coordinates on the tactile sensor of the mobile phone according to the second method.

FIG. 12 shows a concept of a third method for selecting a scroll condition applicable to the mobile phone of the embodiment of the present invention.

FIG. 13 is a functional block diagram of the mobile phone to illustrate the third method.

FIG. 14 is a flow chart of the third method.

FIG. 15 illustrates sequential detection of an object at coordinates on the tactile sensor of the mobile phone according to the third method.

FIG. 16 shows a concept of a fourth method for selecting a scroll condition applicable to the mobile phone of the embodiment of the present invention.

FIG. 17 is a functional block diagram of the mobile phone to illustrate the fourth method.

FIG. 18 is a flow chart of the fourth method.

FIG. 19 shows a concept of a fifth method for selecting a scroll condition applicable to the mobile phone of the embodiment of the present invention.

FIG. 20 is a functional block diagram of the mobile phone to illustrate the fifth method.

FIG. 21 is a flow chart of the fifth method.

FIG. 22 shows a concept of a sixth method for selecting a scroll condition applicable to the mobile phone of the embodiment of the present invention.

FIG. 23 is a flow chart of the sixth method.

FIG. 24 is a functional block diagram of the mobile phone to illustrate a seventh method for selecting a scroll condition applicable to the mobile phone of the embodiment of the present invention.

FIG. 25 is a former half of a flow chart of the seventh method.

FIG. 26 is a latter half of the flow chart of the seventh method.

### DETAILED DESCRIPTION OF THE INVENTION

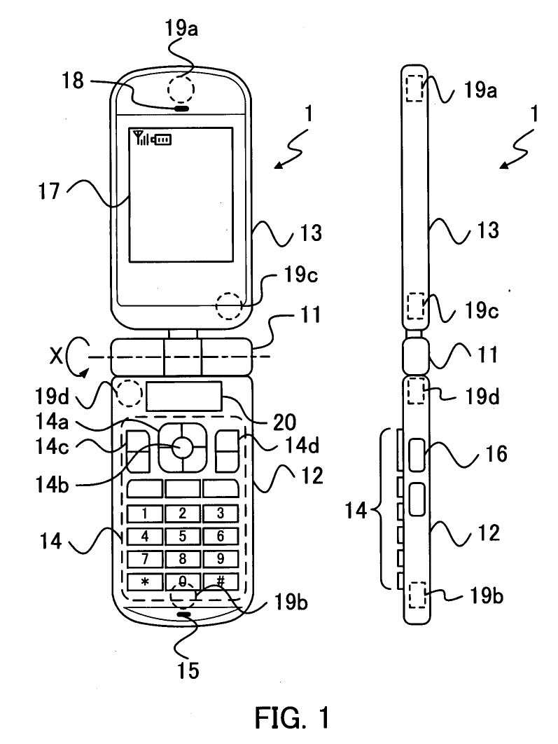

An embodiment of the present invention will be described with reference to FIGS. 1-3. FIG. 1 shows an external view of a mobile phone 1 having a built-in camera. The mobile phone 1 is a data processing apparatus of the embodiment of the present invention. FIG. 1 shows on its left-hand side a front view of the mobile phone 1 being in about 180 degrees open configuration. FIG. 1 shows on its right-hand side a side view of the mobile phone 1 being open about 180 degrees.

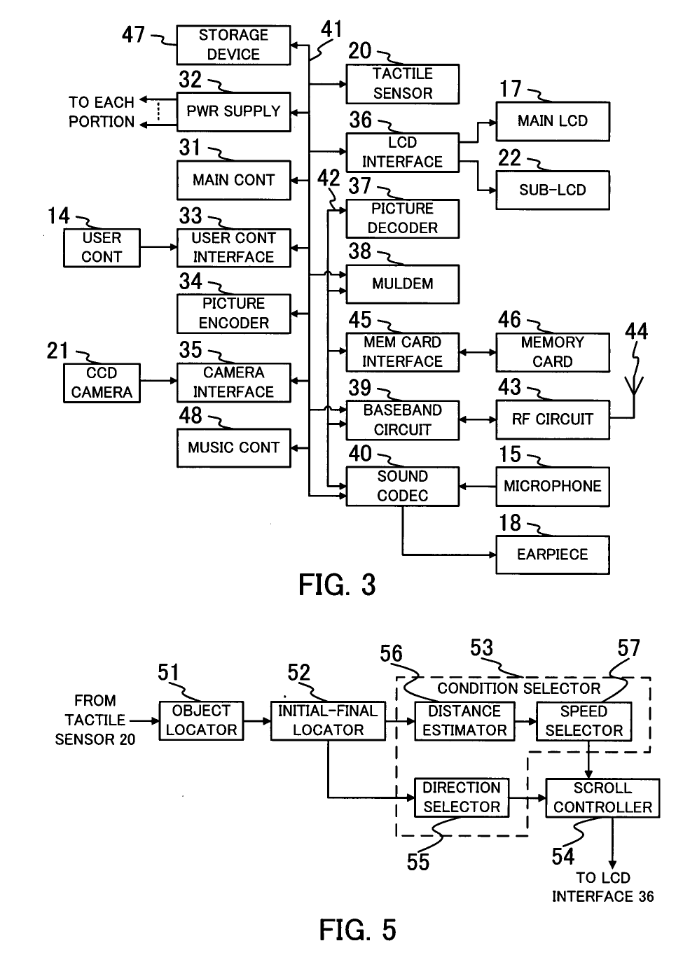

As shown in FIG. 1, the mobile phone 1 is configured in a housing including a connection 11, a first section 12 and a second section 13. The connection 11 movably connects the second section 13 to the first section 12. If the second section 13 rotates around the connection 11 as directed by a circular arrow “X” shown in FIG. 1, the housing of the mobile phone 1 may be flipped into a folded configuration. The mobile phone 1 includes a built-in antenna (not shown but to be shown later in FIG. 3, given a reference numeral 44). The mobile phone 1 may send and receive radio waves to and from a base station (not shown) by way of the antenna 44.

The first section 12 is provided on a front face thereof with a set of user controls 14 including numeric keys from 0 to 9, a send key, a redial key, a power and end key, a clear key and an email key. Through operation done on the set of user controls 14, various instructions and information may be entered into the mobile phone 1.

The first section 12 is provided, on an upper area thereof as shown in FIG. 1, with a 4-way navigation key 14a and a selection key 14b, both included in the set of user controls 14. On a front face of the second section 13, provided is a main liquid crystal display (LCD) 17. The 4-way navigation key 14a may be used for moving a cursor not shown in FIG. 1 but presented on the main LCD 17, up, down, left or right. The 4-way navigation key 14a may thereby be used for scrolling a phone number directory or a text page of an email presented on the main LCD 17, for turning pages of a simple homepage, for fast-forwarding pictures and so on.

The selection key 14b may be used for selecting various menus, functions and so on. Assume, for instance, that the cursor is placed on a preselected phone number included in the directory presented on the main LCD 17 according to operation of the 4-way navigation key 14a. If the selection key 14b is pressed inwards, the mobile phone 1 selects the preselected phone number and requests a call to the selected phone number.

The first section 12 is provided with an email key 14c on the left of the 4-way navigation key 14a and the selection key 14b. If the email key 14c is pressed inwards, the mobile phone 1 may activate a function for sending and receiving emails. The first section 12 is provided with a browser key 14d on the right of the 4-way navigation key 14a and the selection key 14b. If the browser key 14d is pressed inwards, the mobile phone 1 may browse Web pages on the main LCD 17.

Various functions may be assigned to the email key 14c and the browser key 14d depending on a type of screens displayed on the main LCD 17. In a case where a user has to reply yes or no in a process of operation, for instance, “YES” and “NO” may be assigned to the email key 14c and the browser key 14d, respectively. The email key 14c and the browser key 14d are thus called a first soft key and a second soft key, respectively.

The first section 12 is provided with a microphone 15 under the set of user controls 14 as shown in FIG. 1. The microphone 15 may pick up user's voice during a voice call. The first section 12 is provided on a side thereof with a side key 16 usable for operation of the mobile phone 1.

The first section 12 is provided on a back thereof with a battery pack (not shown). If the power and end key is pressed and the mobile phone 1 is turned on, each portion of the mobile phone 1 is supplied with power from the battery pack and gets ready to start operating.

The first section 12 is provided at a given location in a lower portion thereof with a memory card slot (not shown) for installing or uninstalling a memory card, and provided with a memory button (not shown). If the memory button is pressed during a voice call, the mobile phone 1 may record received voice on the memory card. The mobile phone 1 may record emails, simple homepages, pictures taken by a built-in charge coupled device (CCD) camera and so forth on the memory card.

The memory card is a kind of flash memory (NAND or NOR) cards. The memory card contains in a small and thin plastic package a nonvolatile, electrically erasable and rewritable flash memory device. The memory device may write and read various data of pictures, voice, music, and so on through terminals of its 10-pin package.

The memory card adopts a unique serial protocol which assures compatibility among devices using the memory card even in a case where specification of the built-in flash memory device is updated for higher capacity. The memory card enables high-speed access. The memory card assures high reliability by including an erase protection switch to prevent accidental deletion of data.

As being configured to install the memory card, the mobile phone 1 may use data in common with other electronic apparatus through the memory card.

The memory card may include a built-in module or chip to be adapted for an optional function. Having installed the memory card in the memory card slot (not shown) including the built-in module, the mobile phone 1 may perform the optional function.

Assume, for instance, that the mobile phone 1 includes no built-in non-contact type integrated circuit (IC) chip, and installs a memory card that includes a non-contact type IC chip. Although not adapted by itself for an optional function such as electronic settlement, the mobile phone 1 may perform the optional function by using the non-contact type IC chip included in the memory card.

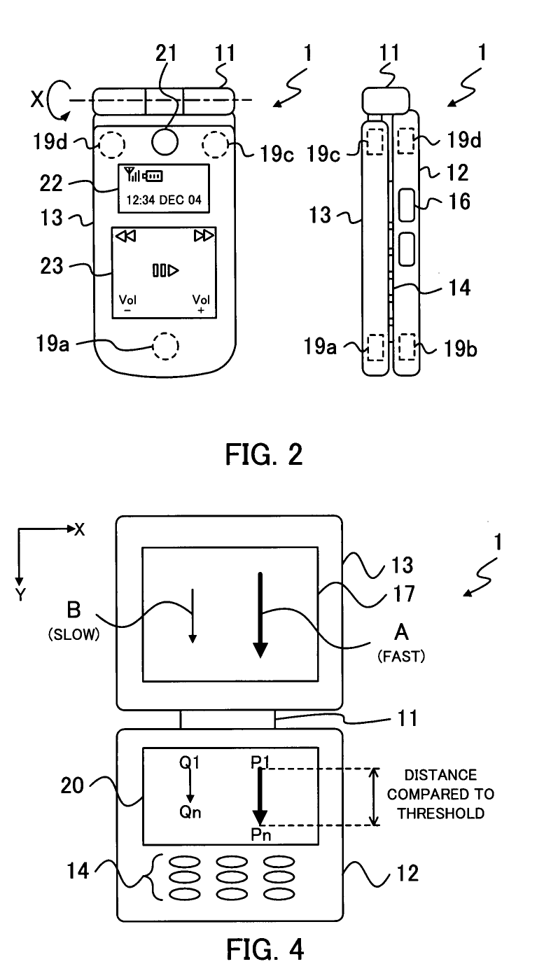

The main LCD 17 provided on the front face of the second section 13 may display a signal strength indicator, a battery level indicator, a directory including a name and a phone number of each entry, or a transmission history log. The main LCD 17 may display text of emails, simple homepages, or pictures taken by the built-in CCD camera (not shown but to be shown later in FIG. 2, given a reference numeral 21).

The main LCD 17 may display content received from an outside content server (not shown), or content stored in the memory card (not shown but to be shown later in FIG. 3, given a reference numeral 46). The second section 13 is provided above the main LCD 17 with an earpiece 18 usable for voice calls.

The second section 13 is provided with magnetic sensors 19a and 19c at a location given for each. The first section 12 is provided with magnetic sensors 19b and 19d at a location given for each. The magnetic sensors 19a, 19b, 19c and 19d may sense a configuration of the housing of the mobile phone 1, i.e., whether folded or open.

The first section 12 is provided with a tactile sensor 20 formed by highly integrated pressure sensors and so on. The tactile sensor 20 has a sensing surface, and may sequentially detect an external object that touches and moves on the sensing surface.

FIG. 2 shows another external view of the mobile phone 1 being in the folded configuration, i.e., after the second section 13 rotates as directed by the circular arrow “X” shown in FIG. 1. FIG. 2 shows on its left-hand side a front view of the mobile phone 1 in the folded configuration. FIG. 2 shows on its right-hand side a side view of the mobile phone 1 in the folded configuration.

The second section 13 is provided on an upper portion thereof, as shown in FIG. 2, with the CCD camera 21 that may take a picture of any object. The second section 13 is provided under the CCD camera 21, as shown in FIG. 2, with a sub-LCD 22 which may present a signal strength indicator indicating strength of a signal received by the antenna 44, a battery level indicator, current time and date, and so on.

The second section 13 is provided under the sub-LCD 22, as shown in FIG. 2, with an electrostatic touchpad 23 which looks like a single touchpad but includes a plurality of sensors (not shown). Upon being touched on and around each of the sensors, the electrostatic touchpad 23 produces a signal for controlling a play of music, such as play, pause, rewind, fast forward, decrease or increase loudness.

FIG. 3 is a block diagram of the mobile phone 1. As shown in FIG. 3, the mobile phone 1 includes a main controller 31 which comprehensively controls each portion contained in the first section 12 and the second section 13.

The mobile phone 1 includes a power supply 32, a user control interface 33, a picture encoder 34, a camera interface 35, an LCD interface 36, a multiplexer/demultiplexer (muldem) 38, a baseband circuit 39, a sound codec 40, a storage device 47 and a music controller 48, each of which is coupled to the main controller 31 via a main bus 41.

The mobile phone 1 includes a picture decoder 37 and a memory card interface 45. The picture decoder 37, the muldem 38, the baseband circuit 39, the sound codec 40 and the memory card interface 45 are coupled to one another via a synchronization bus 42. The mobile phone 1 includes a radio frequency (RF) circuit 43 coupled to the baseband circuit 39, and the antenna 44 coupled to the RF circuit 43.

If the power and end key is turned on, the power supply 32 starts supplying each portion of the mobile phone 1 with power from the battery pack included in the power supply 32. The mobile phone 1 then gets ready to work.

The main controller 31 is formed by a central processing unit (CPU), a read-only memory (ROM), a random access memory (RAM) and so on. The CPU may run various processes based on a program stored in the ROM or various application programs loaded from the storage device 47 to the RAM.

The CPU may produce a control signal to send to each portion of the mobile phone 1, and may thereby comprehensively control the mobile phone 1. The RAM may read and write data as necessary while the CPU runs various processes. The CPU includes a clock indicating current time and date.

Each of the application programs may be stored in the ROM or in the storage device 47 in advance. Each of the application programs may be downloaded by radio via a base station (not shown) and stored in the storage device 47. Each of the application programs may be stored in the memory card 46, read out by the memory card interface 45 and stored in the storage device 47.

During a voice call, the mobile phone 1 processes outgoing and incoming voice signals as controlled by the main controller 31 as follows. In order to send outgoing voice, the microphone 15 picks up a voice input to produce an analog voice signal. The sound codec 40 analog-to-digital (A/D) converts the analog voice signal and compresses the converted digital voice signal. The baseband circuit 39 spreads spectrum of the compressed voice signal. The RF circuit 43 digital-to-analog (D/A) converts and then up-converts the spectrum-spread voice signal into an outgoing RF voice signal, which is finally transmitted via the antenna 44.

In order to receive incoming voice, an incoming RF voice signal arrives at the antenna 44. Upon receiving the incoming RF voice signal via the antenna 44, the RF circuit 43 amplifies, down-converts and A/D converts the received voice signal. The baseband circuit 39 despreads spectrum of the received digital voice signal. The sound codec 40 expands and D/A converts the spectrum-despread voice signal. The sound codec 40 provides the earpiece 18 with the converted analog voice signal, and the earpiece 18 reproduces a voice output accordingly.

In order to send an outgoing email during data communication, the main controller 31 obtains text entered on the set of user controls 14 via the user control interface 33. The main controller 31 provides the baseband circuit 39 with a digital signal representing the entered text of the outgoing email. The baseband circuit 39 spreads spectrum of the above signal of the outgoing email. The RF circuit 43 digital-to-analog converts and then up-converts the spectrum-spread signal of the outgoing email into an RF signal of the outgoing email, which is finally transmitted via the antenna 44.

Upon receiving an RF signal carrying an incoming email which arrives at the antenna 44, the RF circuit 43 amplifies, down-converts and analog-to-digital converts the above received email signal. The baseband circuit 39 despreads spectrum of the received email signal so as to reproduce text of the received email. The main controller 31 obtains the text of the received email, and provides the main LCD 17 via the LCD interface 36 with the text of the received email.

The mobile phone 1 may store the text of the received email in the memory card 46 via the memory card interface 45 according to operation done on the set of user controls 14.

The mobile phone 1 may present a picture taken by the CCD camera 21 on the main LCD 17 via the camera interface 35 and the LCD interface 36 so as to immediately present the picture while not sending outwards data of the picture.

In order to send outwards data of a picture taken by the CCD camera 21, the mobile phone 1 provides the picture encoder 34 with a picture signal produced by the CCD camera 21 via the camera interface 35. While the CCD camera 21 is taking the picture, the microphone 15 may pick up sound including voice so as to provide the sound codec 40 with an analog sound signal.

The picture encoder 34 may encode the picture signal by compression according to a given encoding method, e.g., Moving Picture Experts Group (MPEG) 4, so as to provide the muldem 38 with an encoded picture signal. The sound codec 40 may encode the analog sound signal so as to provide the muldem 38 with a digital sound signal.

The muldem 38 may multiplex the encoded picture signal provided by the picture encoder 34 and the digital sound signal provided by the sound codec 40 according to a given multiplexing method so as to provide the baseband circuit 39 with a multiplexed signal. The baseband circuit 39 spreads spectrum of the multiplexed signal. The RF circuit 43 D/A converts and then up-converts the spectrum-spread multiplexed signal into an outgoing RF multiplexed signal, which is finally transmitted via the antenna 44.

Meanwhile, the mobile phone 1 may receive data of Web pages during data communication. If the mobile phone 1 requests a Web page, a set of data of the Web page is sent carried by an RF signal via a base station (not shown in FIG. 3) in response to the request. The RF signal carrying the set of data of the Web page arrives at the antenna 44 and is received by the RF circuit 43. The set of data of the Web page is then reproduced by the baseband circuit 39, and is provided to the main controller 31.

The main controller 31 interprets the received data of the Web page and prepares data of a screen (a picture) based on the interpretation. The main controller 31 provides the main LCD 7 via the LCD interface 36 with the data of the screen so as to display the screen on the main LCD 17.

In the ROM of the main controller 31 or in the storage device 47, installed is an application program of Web browsing. The CPU of the main controller 31 may work as a Web browser and may interpret the received data of the Web page as described above by running the application program of Web browsing.

The mobile phone 1 may receive during data communication a data file which links to a Web page and includes, e.g., a moving picture and associated sound. The data file is carried by an RF signal and arrives at the antenna 44. The RF signal is received by the RF circuit 43, down-converted, A/D converted, and then its spectrum is despread by the baseband circuit 39 so as to reproduce a multiplexed signal of the moving picture and the sound, and to provide the muldem 38 with the multiplexed signal.

The muldem 38 separates an encoded signal of the moving picture and a sound signal by demultiplexing the multiplexed signal. The muldem 38 provides the picture decoder 37 with the encoded moving picture signal and provides the sound codec 40 with the sound signal. The picture decoder 37 decodes the encoded moving picture signal according to a given encoding method like MPEG4 so as to reproduce a signal of the moving picture before being encoded. The picture decoder 37 provides the main LCD 17 via the LCD interface 36 with the reproduced moving picture signal. The mobile phone 1 may thereby display on the main LCD 17 a moving picture, e.g., included in the data file which links to the Web page.

Meanwhile, the sound codec 40 converts the sound signal from digital to analog, and provides the earpiece 18 with the digital sound signal. The mobile phone 1 may thereby reproduce sound, e.g., included in the data file which links to the Web page. In this event, the mobile phone 1 may store content of the data file which links to the Web page in the memory card 46 via the memory card interface 45 according to operation done on the set of user controls 14, in a manner similar to storing text of a received email.

The storage device 47 is formed by, e.g., a nonvolatile, electrically erasable and rewritable flash memory device. The storage device 47 may store various application programs which may be run by the CPU of the main controller 31, and may store various groups of data. The storage device 47 may store a received email or data of a moving picture included in a data file which links to a Web page as necessary according to operation done on the set of user controls 14.

The music controller 48 may control a play of music stored in the storage device 47, such as play, pause, rewind, fast forward, decrease or increase loudness.

The tactile sensor 20 may sequentially detect an object like a finger or a stylus so as to provide the main controller 31 via the main bus 41 with a signal of detection. The signal of detection contains information about a location of the object, e.g., represented by (X, Y) coordinates on the sensing surface the tactile sensor 20. The signal of detection contains information about how much pressure is applied to the tactile sensor 20 at the location of the object.

A first method for selecting a scroll condition applicable to the mobile phone 1, one of data processing apparatus of the embodiment of the present invention, will be described with reference to FIGS. 4-7.

FIG. 4 shows a concept of the first method by using a simplified drawing of the mobile phone 1 being in the open configuration. Each portion of the mobile phone 1 shown in FIG. 4 is a same as the corresponding one given the same reference numeral shown in FIG. 1, and its explanation is omitted.

FIG. 4 illustrates a case where an object is sequentially detected between an initial location “P1” and a final location “Pn” on the tactile sensor 20. That is, the object is detected first at “P1”, keeps in contact with and moves on the tactile sensor 20 from “P1” to “Pn”, and then leaves the tactile sensor 20 at “Pn”. A distance between “P1” and “Pn” is assumed to be greater than a given threshold.

FIG. 4 illustrates another case where an object is sequentially detected between an initial location “Q1” and a final location “Qn” on the tactile sensor 20. That is, the object is detected first at “Q1”, keeps in contact with and moves on the tactile sensor 20 from “Q1” to “Qn”, and then leaves the tactile sensor 20 at “Qn”. A distance between “Q1” and “Qn” is assumed to be no greater than the given threshold.

The mobile phone 1 adopting the first method is configured to select a scroll direction depending on a direction in which a detected object has moved on the tactile sensor 20, and configured to select a scroll speed depending on a distance between initial and final locations of the object on the tactile sensor 20.

In the above case where the object moves from “P1” to “Pn”, the mobile phone 1 selects a downward scroll direction as the object moves downwards, and selects a fast scroll speed given a value “A” as the distance between “P1” and “Pn” is greater than the given threshold. In the above case where the object moves from “Q1” to “Qn”, the mobile phone 1 selects a downward scroll direction as the object moves downwards, and selects a slow scroll speed given a value “B” as the distance between “Q1” and “Qn” is no greater than the given threshold.

The mobile phone 1 may thereby select a scroll condition for scrolling a screen on the main LCD 17 after the tactile sensor 20 sequentially detects an object (e.g., a finger or a stylus) that moves on the tactile sensor 20. The screen may be scrolled on the main LCD 17 in the selected scroll condition.

FIG. 5 is a functional block diagram of the mobile phone 1, one of data processing apparatus of the embodiment of the present invention, adopting the first method. Each of functional blocks shown in FIG. 5 may be implemented by at least one of the portions of the mobile phone 1 shown in FIG. 3.

In FIG. 5, the tactile sensor 20 provides an object locator 51 with a signal of detection of an object (e.g., a finger or a stylus, which is not shown) that is sequentially detected on the tactile sensor 20. The object locator 51 may be implemented by the main controller 31. The object locator 51 sequentially locates the object on the tactile sensor 20, and provides an initial-final locator 52 with object location data.

The initial-final locator 52 may be implemented by the main controller 31. The initial-final locator 52 locates an initial location and a final location of the object based on the object location data provided by the object locator 51. The initial-final locator 52 provides a condition selector 53 with initial location data and final location data of the object.

The condition selector 53 includes three functional blocks, a direction selector 55, a distance estimator 56 and a speed selector 57. A whole and each block of the condition selector 53 may be implemented by the main controller 31. The distance estimator 56 is configured to estimate a distance between the initial location and the final location on the tactile sensor 20. The direction selector 55 and the speed selector 57 are configured to select a scroll direction and a scroll speed for scrolling a screen on the main LCD 17, respectively.

The direction selector 55 is provided with the initial location data and the final location data of the object by the initial-final locator 52. The direction selector 55 determines whether the final location is located higher (i.e., nearer to the connection 11) or lower than the initial location.

Upon determining that the final location is located higher than the initial location, the direction selector 55 determines that the object has moved upwards (i.e., toward the connection 11) and selects an upward scroll direction. Upon determining that the final location is located lower than the initial location, the direction selector 55 determines that the object has moved downwards and selects a downward scroll direction. The direction selector 55 provides a scroll controller 54 with selected direction data.

The distance estimator 56 is provided with the initial location data and the final location data by the initial-final locator 52. The distance estimator 56 estimates a distance between the initial location and the final location on the tactile sensor 20 based on the initial location data and the final location data represented by two-dimensional coordinates. The distance estimator 56 provides the speed selector 57 with estimated distance data.

The speed selector 57 is provided with the estimated distance data by the distance estimator 56. The speed selector 57 determines whether the estimated distance is greater than the given threshold. Upon determining that the estimated distance is greater than the given threshold, the speed selector 57 selects the fast scroll speed “A” as shown in FIG. 4. Upon determining that the estimated distance is no greater than the given threshold, the speed selector 57 selects the slow scroll speed “B” as shown in FIG. 4. The speed selector 57 provides the scroll controller 54 with selected speed data.

The scroll controller 54 may be implemented by the main controller 31. The scroll controller 54 is provided with the selected direction data by the direction selector 55. The scroll controller 54 is provided with the selected speed data by the speed selector 57. The scroll controller 54 controls operation of scrolling a screen displayed on the main LCD 17 according to the selected scroll direction and the selected scroll speed.

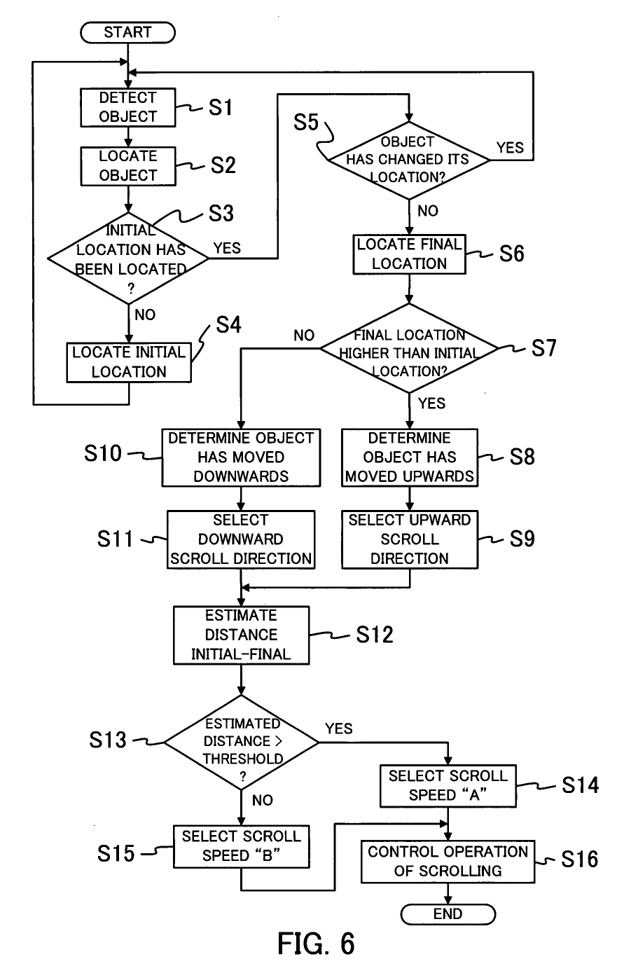

A flow of operation of the first method for selecting a scroll condition of the embodiment of the present invention will be described with reference to FIG. 6, a flow chart of the first method. The operation starts after an object (e.g., a finger or a stylus) is detected first at an initial location on the tactile sensor 20, which is fit in place on the mobile phone 1 as earlier described.

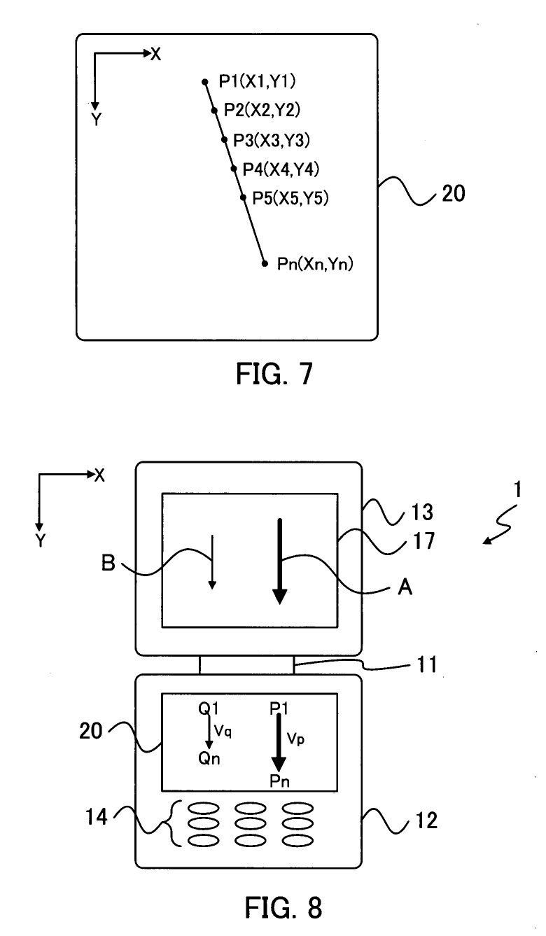

The tactile sensor 20 sequentially detects the object and provides the object locator 51 with a signal of detection (step S1). The signal of detection contains information about a location of the object on the sensing surface of the tactile sensor 20 (e.g., represented by (X, Y) coordinates as shown in FIG. 7, where the X coordinate is given on a horizontal X axis being positive right, and the Y coordinate is given on a vertical Y axis being positive downwards, both in FIG. 4 and in FIG. 7). The signal of detection contains information about how much pressure is applied to the tactile sensor 20 at the location of the object.

The object locator 51 sequentially locates the object on the tactile sensor 20, and provides the initial-final locator 52 with object location data (step S2). The initial-final locator 52 is provided with the object location data and determines whether an initial location of the object has been located (step S3).

Upon determining that no initial location of the object has been located yet (“NO” of step S3), the initial-final locator 52 locates an initial location of the object (e.g., “P1” shown in FIG. 7) based on the object location data (step S4). The initial-final locator 52 provides the direction selector 55 and the distance estimator 56, both included in the condition selector 53, with initial location data including location data represented by (X, Y) coordinates and an initial flag saying that the location data is of the initial location.

As shown in FIG. 7, for instance, the initial location data includes the location data of “P1”, i.e., (X1, Y1), and the initial flag saying that “P1” is the initial location. The flow of operation then goes back to the step S1, and repeats the steps following the step 1 described above.

Upon determining that the initial location of the object has been located (“YES” of step S3), the initial-final locator 52 locates a latest location of the object and determines whether the object has changed its location on the tactile sensor 20 (step S5). If the initial-final locator 52 determines that the object has changed its location (“YES” of step S5), the flow of operation goes back to the step S1 and repeats the steps following the step 1 described above.

As shown in FIG. 7, for instance, if the object is detected at a location “P5” after being detected at a location “P4”, the initial-final locator 52 determines that the object has changed its location. The steps of sequentially detecting and locating the object on the tactile sensor 20 are repeated as long as the object keeps in contact with and moves on the tactile sensor 20.

Upon determining that the object has not changed its location, or that the object is no longer detected, the initial-final locator 52 locates a final location at the latest location of the object (e.g., a final location “Pn” shown in FIG. 7) (step S6).

The initial-final locator 52 provides the direction selector 55 and the distance estimator 56, both included in the condition selector 53, with final location data including location data represented by (X, Y) coordinates and a final flag saying that the location data is of the final location. As shown in FIG. 7, for instance, the final location data includes the location data of “Pn”, i.e., (Xn, Yn), and the final flag saying that “Pn” is the final location.

The direction selector 55 determines whether the final location is located higher or lower than the initial location based on the initial location data and the final location data both provided by the initial-final locator 52 (step S7). That is, the direction selector 55 determines whether a Y-coordinate value of the final location is greater or smaller than that of the initial location. As shown in FIG. 7, for instance, the Y-coordinate value of the final location “Pn” is greater than that of the initial location “P1”, the direction selector 55 determines that the final location “Pn” is located lower than the initial location “P1”.

Upon determining that the final location of the object is located higher than the initial location (“YES” of step S7), the direction selector 55 determines that the object has moved upwards (step S8). The direction selector 55 selects an upward scroll direction for scrolling a screen displayed on the main LCD 17 (step S9). The direction selector 55 provides the scroll controller 54 with upward direction data.

Upon determining that the final location of the object is located lower than the initial location (“NO” of step S7), the direction selector 55 determines that the object has moved downwards (step S10). The direction selector 55 selects a downward scroll direction for scrolling a screen displayed on the main LCD 17 (step S11). The direction selector 55 provides the scroll controller 54 with downward direction data.

The distance estimator 56 estimates a distance between the initial location and the final location based on the initial location data and the final location data both provided by the initial-final locator 52 (step S12). As shown in FIG. 7, for instance, the distance estimator 56 estimates a distance between the initial location “P1” and the final location “Pn”. The distance estimator 56 provides the speed selector 57 with estimated distance data.

The speed selector 57 determines whether the distance between the initial location and the final location is greater than a given threshold based on the estimated distance data provided by the distance estimator 56 (step S13).

Upon determining that the distance between the initial location and the final location is greater than the given threshold (“YES” of step S13), the speed selector 57 selects the fast scroll speed “A” (step S14). The speed selector 57 provides the scroll controller 54 with fast speed data.

Upon determining that the distance between the initial location and the final location is no greater than the given threshold (“NO” of step S13), the speed selector 57 selects the slow scroll speed “B” (step S15). The speed selector 57 provides the scroll controller 54 with slow speed data.

The scroll controller 54 controls operation of scrolling a screen displayed on the main LCD 17 based on the upward or downward direction data provided by the direction selector 55 and the fast or slow speed data provided by the speed selector 57 (step S16).

The scroll controller 54 controls the LCD interface 36 so that a screen displayed on the main LCD 17 may be scrolled according to the selected scroll direction and the selected scroll speed. If the upward scroll direction and the fast scroll speed are selected, for instance, the screen may be scrolled upwards at the fast scroll speed “A”.

According to the first method described above, the tactile sensor 20 fit in place on the mobile phone 1 may sequentially detect the object (e.g., a finger or a stylus) so that the initial and final locations of the object are located on the sensing surface of the tactile sensor 20. The scroll direction and the scroll speed may be selected based on the initial location data and the final location data.

The mobile phone 1 may thereby enable quick and easy selection of a preferred scroll condition despite of a limited resource of the mobile phone 1 so that a screen displayed on the main LCD 17 may be scrolled in the preferred scroll condition. The mobile phone 1 may thereby be comfortably operated by using the first method.

The scroll direction may be selected not only upwards or downwards, but also rightwards, leftwards or at a slant. The scroll controller 54 may continue scrolling until the object leaves the tactile sensor 20. After starting scrolling, the scroll controller 54 may continue scrolling even after the object leaves the tactile sensor 20, and may stop scrolling if the object is detected by the tactile sensor 20 again.

The scroll speed may be selected not only out of two values, fast and slow, but also out of, e.g., five values which are “A” (fastest), “B”, “C”, “D” and “E” (slowest). A screen displayed on the main LCD 17 may thereby be scrolled in a more preferred manner.

The scroll speed may be selected not only based on the distance between the initial location and the final location as by the first method, but in a more intuitive manner based on an average moving speed of the object estimated between the initial location and the final location.

Such a method by using the average moving speed of the object will be described as a second method for selecting a scroll condition applicable to the mobile phone 1, one of data processing apparatus of the embodiment of the present invention, with reference to FIGS. 8-11.

FIG. 8 shows a concept of the second method by using a simplified drawing of the mobile phone 1 like FIG. 4 of the first method. Each portion of the mobile phone 1 shown in FIG. 8 is a same as the corresponding one given the same reference numeral shown in FIG. 1, and its explanation is omitted.

FIG. 8 illustrates a case where an object is sequentially detected between an initial location “P1” and a final location “Pn” on the tactile sensor 20. That is, the object is detected first at “P1”, keeps in contact with and moves at an average moving speed “Vp” on the tactile sensor 20 from “P1” to “Pn”, and then leaves the tactile sensor 20 at “Pn”. The average moving speed “Vp” is assumed to be greater than a given threshold.

FIG. 8 illustrates another case where an object is sequentially detected between an initial location “Q1” and a final location “Qn” on the tactile sensor 20. That is, the object is detected first at “Q1”, keeps in contact with and moves at an average moving speed “Vq” on the tactile sensor 20 from “Q1” to “Qn”, and then leaves the tactile sensor 20 at “Qn”. The average moving speed “Vq” is assumed to be no greater than the given threshold.

The mobile phone 1 adopting the second method is configured to select a scroll direction depending on a direction in which a detected object has moved on the tactile sensor 20, and configured to select a scroll speed depending on an average moving speed of the object on the tactile sensor 20.

In the above case where the object moves from “P1” to “Pn”, the mobile phone 1 selects a downward scroll direction as the object moves downwards, and selects a fast scroll speed given a value “A” as the average moving speed of the object “Vp” is greater than the given threshold. In the above case where the object moves from “Q1” to “Qn”, the mobile phone 1 selects a downward scroll direction as the object moves downwards, and selects a slow scroll speed given a value “B” as the average moving speed “Vq” is no greater than the given threshold.

The mobile phone 1 may thereby select a scroll condition for scrolling a screen on the main LCD 17 after the tactile sensor 20 sequentially detects an object (e.g., a finger or a stylus) that moves on the tactile sensor 20. The screen may be scrolled on the main LCD 17 in a preferred scroll condition selected in an intuitive manner by using the second method.

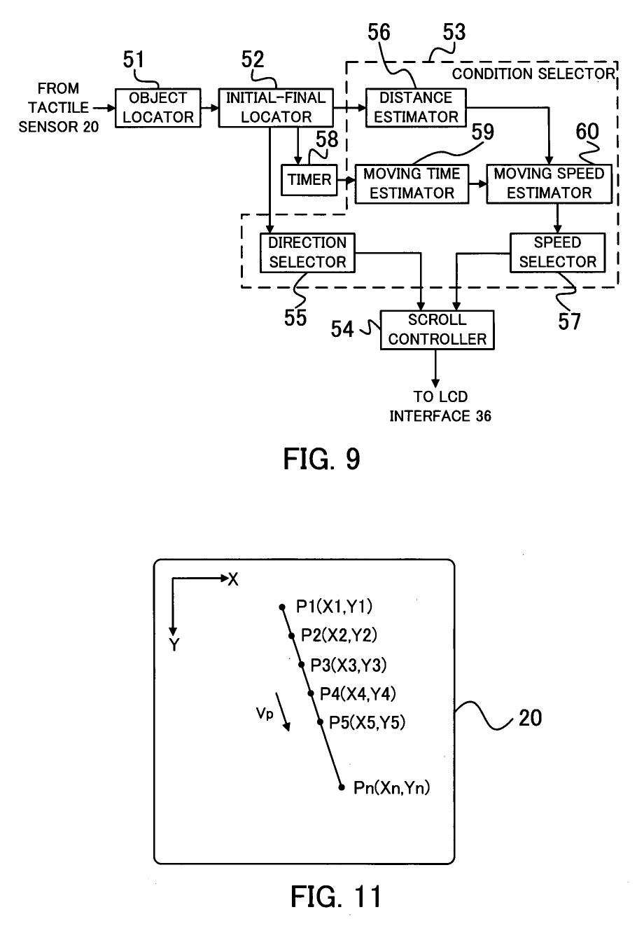

FIG. 9 is a functional block diagram of the mobile phone 1, one of data processing apparatus of the embodiment of the present invention, adopting the second method. Each of functional blocks shown in FIG. 9 may be implemented by at least one of the portions of the mobile phone 1 shown in FIG. 3. Each of the functional blocks which is a same as the corresponding one shown in FIG. 5 is given the same reference numeral, and its explanation is omitted.

In FIG. 9, the initial-final locator 52 locates an initial location and a final location of an object based on object location data provided by the object locator 51. The initial-final locator 52 provides the condition selector 53 with initial location data and final location data.

After locating the initial location based on the object location data, the initial-final locator 52 instructs a timer 58 to start. After locating the final location based on the object location data, the initial-final locator 52 instructs the timer 58 to stop.

The condition selector 53 includes five functional blocks, the direction selector 55, the distance estimator 56, the speed selector 57, a moving time estimator 59 and a moving speed estimator 60. The distance estimator 56 is configured to estimate a distance between the initial location and the final location on the tactile sensor 20. The direction selector 55 and the speed selector 57 are configured to select a scroll direction and a scroll speed for scrolling a screen on the main LCD 17, respectively.

The moving time estimator 59 is configured to estimate a period of time for which the object has moved from the initial location to the final location. The moving speed estimator 60 is configured to estimate an average speed at which the object has moved from the initial location to the final location.

The timer 58 may be implemented by, e.g., a clock device included in the main controller 31 shown in FIG. 3. The timer 58 starts upon being instructed to start by the initial-final locator 52. The timer 58 stops upon being instructed to stop by the initial-final locator 52. The timer 58 may provide the moving time estimator 59 with start time data regarding when the timer 58 has started and stop time data regarding when the timer 58 has stopped.

The moving time estimator 59 may be implemented by, e.g., the main controller 31 shown in FIG. 3. The moving time estimator 59 may estimate a period of time for which the object has moved from the initial location to the final location, i.e., moving time of the object, based on the start time data and the stop time data. The moving time estimator 59 provides the moving speed estimator 60 with moving time data.

The moving speed estimator 60 may be implemented by, e.g., the main controller 31 shown in FIG. 3. The moving speed estimator 60 may be provided with the estimated distance data by the distance estimator 56, and with the moving time data by the moving time estimator 59. The moving speed estimator 60 may estimate an average speed at which the object has moved from the initial location to the final location, accordingly. The moving speed estimator 60 provides the speed selector 57 with average moving speed data.

The speed selector 57 is provided with the average moving speed data. The speed selector 57 determines whether the average moving speed is greater than the given threshold. Upon determining that the average moving speed is greater than the given threshold, the speed selector 57 selects the fast scroll speed “A” as shown in FIG. 8. Upon determining that the average moving speed is no greater than the given threshold, the speed selector 57 selects the slow scroll speed “B” as shown in FIG. 8. The speed selector 57 provides the scroll controller 54 with selected speed data.

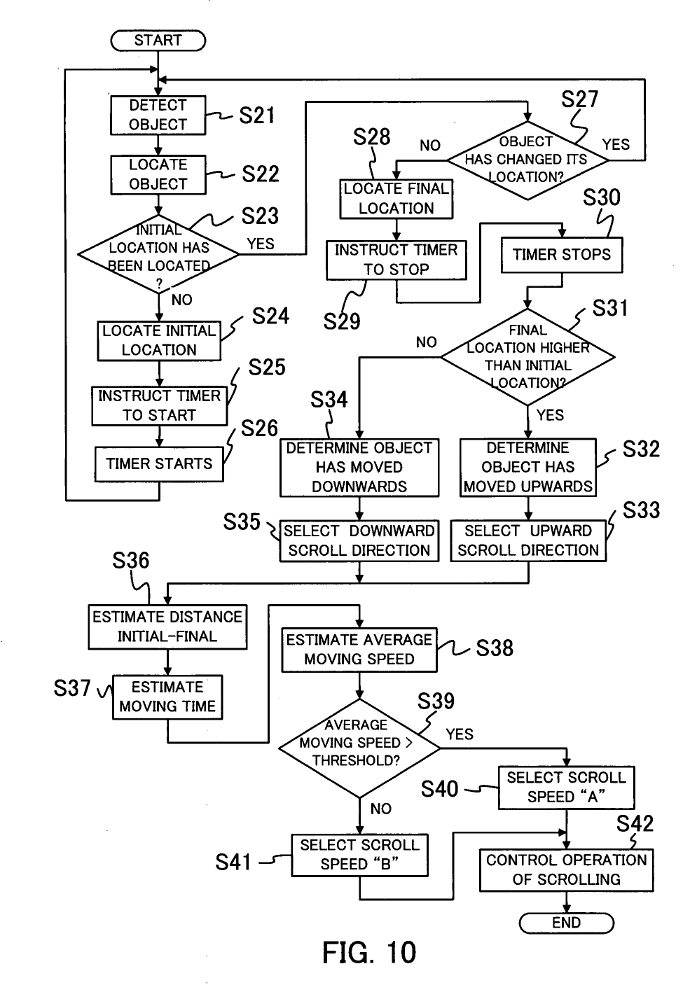

A flow of operation of the second method for selecting a scroll condition of the embodiment of the present invention will be described with reference to FIG. 10, a flow chart of the second method. Note that each of the steps S21-S24, S27, S28, S31-S36 and S42 in FIG. 10 is a same as each of the steps S1-S4, S5, S6, S7-S12 and S16 in FIG. 6, respectively, and its explanation is omitted.

After locating the initial location of the object based on the object location data at the step S24, the initial-final locator 52 instructs the timer 58 to start (step S25). The timer 58 then starts as instructed (step S26). As shown in FIG. 11, for instance, if an object (e.g., a finger or a stylus) is detected at a point “P1” on the tactile sensor 20 and an initial location of the object is located at “P1”, the timer 58 starts. The timer 58 provides the moving time estimator 59 with the start time data regarding when the timer 58 has started. The flow of operation then goes back to the step S21, and repeats the steps following the step 21 described above.

After locating the final location of the object based on the object location data at the step S28, the initial-final locator 52 instructs the timer 58 to stop (step S29). The timer 58 then stops as instructed (step S30). As shown in FIG. 11, for instance, if the object keeps being detected at “Pn” on the tactile sensor 20 for a certain period of time and a final location of the object is located at “Pn”, the timer 58 stops. The timer 58 provides the moving time estimator 59 with the stop time data regarding when the timer 58 has stopped.

The moving time estimator 59 estimates a period of time (moving time) for which the object has moved from the initial location to the final location based on the start time data and the stop time data (step S37). As shown in FIG. 11, for instance, the moving time estimator 59 estimates the moving time of the object for which the object has moved from “P1” to “Pn”. The moving time estimator 59 provides the moving speed estimator 60 with the moving time data.

The moving speed estimator 60 is provided with the distance data by the distance estimator 56 and provided with the moving time data by the moving time estimator 59. The moving speed estimator 60 estimates an average speed at which the object has moved from the initial location to the final location based on the distance data and the moving time data (step S38).

As shown in FIG. 11, for instance, the moving speed estimator 60 estimates an average speed at which the object has moved from the initial location “P1” to the final location “Pn” so as to produce an average moving speed “Vp”. The moving speed estimator 60 provides the speed selector 57 with average moving speed data.

The speed selector 57 is provided with the average moving speed data by the moving speed estimator 60 and determines whether the average moving speed of the object is greater than a given threshold (step S39).

Upon determining that the estimated average moving speed is greater than the given threshold, the speed selector 57 selects the fast scroll speed “A” (step S40), as shown in FIG. 8. Upon determining that the estimated average moving speed is no greater than the given threshold, the speed selector 57 selects the slow scroll speed “B” (step S41), as shown in FIG. 8. The speed selector 57 provides the scroll controller 54 with selected speed data.

The flow of operation goes ahead and the scroll controller 54 controls operation of scrolling a screen displayed on the main LCD 17 in the selected scroll condition (step S42). If the upward scroll direction and the fast scroll speed are selected, for instance, the screen may be scrolled upwards at the fast scroll speed “A”.

According to the second method described above, the tactile sensor 20 fit in place on the mobile phone 1 may sequentially detect the object (e.g., a finger or a stylus) so that the initial and final locations of the object are located on the sensing surface of the tactile sensor 20. The scroll direction may be selected based on the initial location data and the final location data. The scroll speed may be selected based on the average moving speed of the object between the initial location and the final location.

The mobile phone 1 may thereby enable quick and easy selection of a preferred scroll condition in an intuitive manner despite of a limited resource of the mobile phone 1 so that a screen displayed on the main LCD 17 may be scrolled in the preferred scroll condition. The mobile phone 1 may thereby be comfortably operated by using the second method.

The speed selector 57 may select the scroll speed not only based on the average moving speed of the object but also based on, e.g., an estimated maximum moving speed of the object between the initial location and the final location.

The sensing surface of the tactile sensor 20 may be divided into no less than two sub-areas for convenience. The mobile phone 1 may identify from which sub-area to which sub-area the object has moved on the sensing surface of the tactile sensor 20, and may select a scroll condition based on a result of identification.

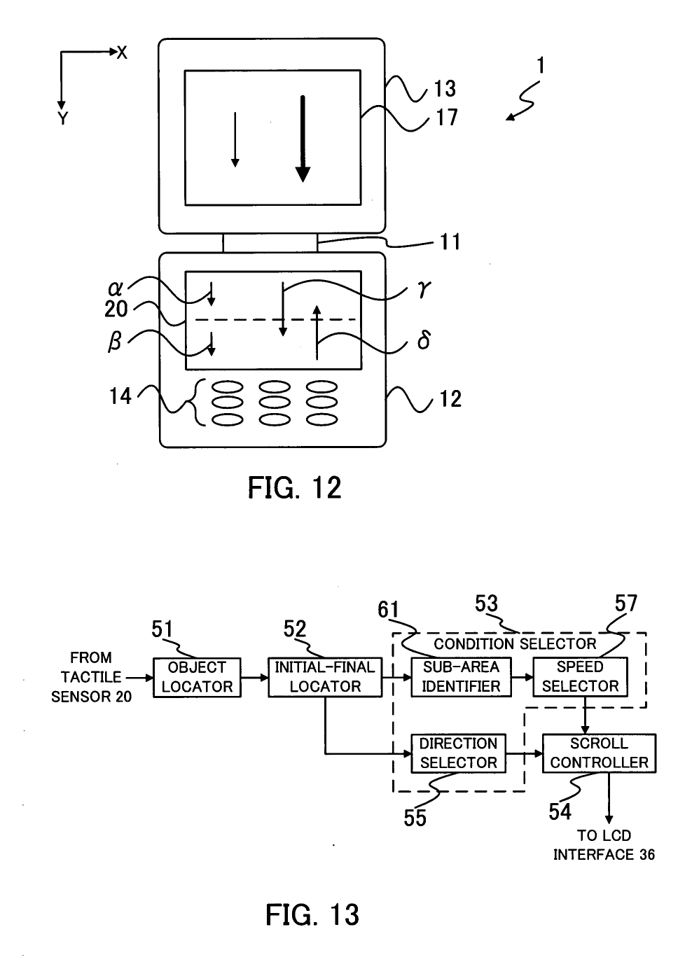

Such a method by using sub-areas of the tactile sensor 20 will be described as a third method for selecting a scroll condition applicable to the mobile phone 1, one of data processing apparatus of the embodiment of the present invention, with reference to FIGS. 12-15.

FIG. 12 shows a concept of the third method by using a simplified drawing of the mobile phone 1 like FIG. 4 of the first method. Each portion of the mobile phone 1 shown in FIG. 12 is a same as the corresponding one given the same reference numeral shown in FIG. 1, and its explanation is omitted.

In FIG. 12, the sensing surface of the tactile sensor 20, fit in place on the mobile phone 1, is divided into an upper sub-area and a lower sub-area by a horizontal dashed line in the middle. Any location on the sensing surface of the tactile sensor 20 is represented by (X, Y) coordinates, as described earlier, and belongs to either one of the upper sub-area and the lower sub-area depending on its (X, Y) coordinates.

FIG. 12 illustrates four cases where an object (not shown) is detected first at an initial location, keeps in contact with and moves on the sensing surface of the tactile sensor 20, and then leaves the tactile sensor 20 at a final location.

In a first case shown by a line “α” where the initial location and the final location are both in the upper sub-area, the mobile phone 1 is configured to select a scroll speed given a value “A”. In a second case shown by a line “β” where the initial location and the final location are both in the lower sub-area, the mobile phone 1 is configured to select a scroll speed given a value “B”.

In a third case shown by a line “γ” where the initial location and the final location are in the upper sub-area and in the lower sub-area, respectively, the mobile phone 1 is configured to select a scroll speed given a value “C”. In a fourth case shown by a line “δ” where the initial location and the final location are in the lower sub-area and in the upper sub-area, respectively, the mobile phone 1 is configured to select a scroll speed given a value “D”.

The mobile phone 1 may thereby select a scroll speed for scrolling a screen on the main LCD 17 after the tactile sensor 20 sequentially detects an object (e.g., a finger or a stylus) that moves on the tactile sensor 20 within or crossing a border of the sub-areas. The screen may be scrolled on the main LCD 17 in a preferred scroll condition selected in a visual manner by using the third method.

FIG. 13 is a functional block diagram of the mobile phone 1, one of data processing apparatus of the embodiment of the present invention, adopting the third method. Each of functional blocks shown in FIG. 13 may be implemented by at least one of the portions of the mobile phone 1 shown in FIG. 3. Each of the functional blocks which is a same as the corresponding one shown in FIG. 5 is given the same reference numeral, and its explanation is omitted.

In FIG. 13, the initial-final locator 52 locates an initial location and a final location of an object based on object location data provided by the object locator 51. The initial-final locator 52 provides the condition selector 53 with initial location data and final location data.

The condition selector 53 includes three functional blocks, the direction selector 55, the speed selector 57 and a sub-area identifier 61. The direction selector 55 and the speed selector 57 are configured to select a scroll direction and a scroll speed for scrolling a screen on the main LCD 17, respectively. The sub-area identifier 61 is configured to identify the sub-area (either the upper sub-area or the lower sub-area) to which the initial location or the final location belongs.

The sub-area identifier 61 may be implemented by, e.g., the main controller 31 shown in FIG. 3. The sub-area identifier 61 is provided with initial location data and final location data by the initial-final locator 52. The sub-area identifier 61 identifies the sub-area to which the initial location belongs and the sub-area to which the final location belongs based on the initial location data and the final location data. The sub-area identifier 61 provides the speed selector 57 with a result of identification. The speed selector 57 selects the scroll speed based on the result of identification.

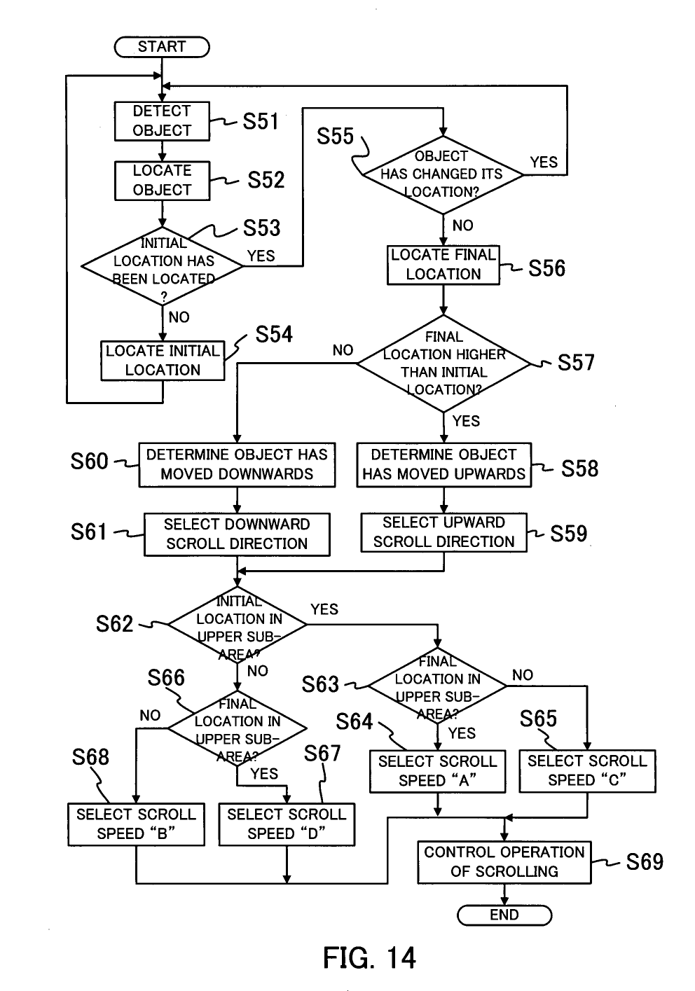

A flow of operation of the third method for selecting a scroll condition of the embodiment of the present invention will be described with reference to FIG. 14, a flow chart of the third method. Note that each of the steps S51-S61 and S69 in FIG. 14 is a same as each of the steps S1-S11 and S16 shown in FIG. 6, respectively, and its explanation is omitted.

The sub-area identifier 61 is provided with the initial location data and the final location data by the initial-final locator 52. The sub-area identifier 61 identifies whether the initial location is in the upper sub-area based on the (X, Y) coordinates included in the initial location data (step S62).

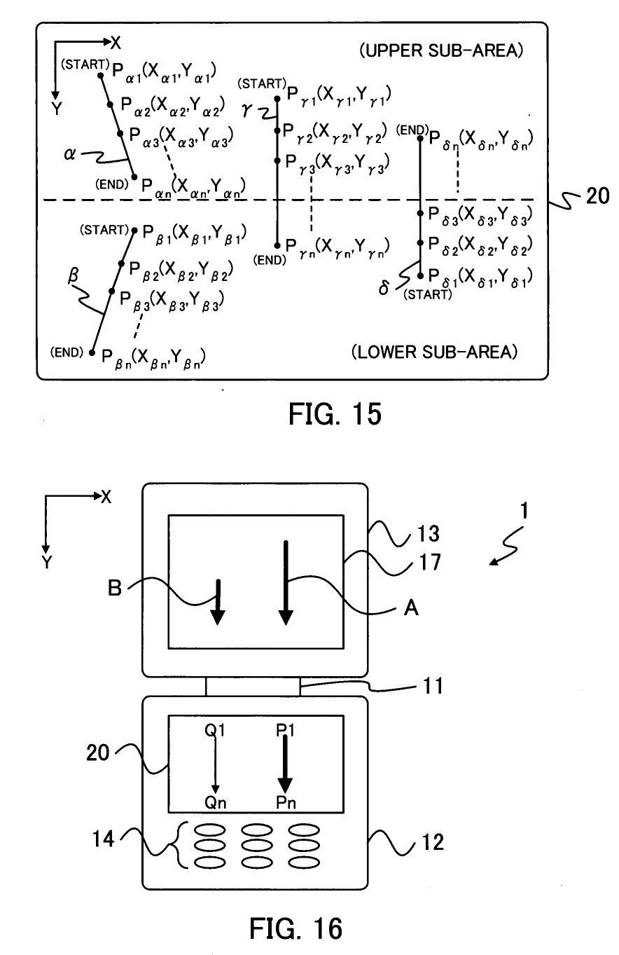

As shown by the line “α” in FIG. 15, for instance, as an initial location “Pα1” is in the upper sub-area (i.e., the (X, Y) coordinates of “Pα1” is included in the upper sub-area), the sub-area identifier 61 identifies the initial location included in the upper sub-area (“YES” of step S62). As shown by the line “γ” in FIG. 15, for instance, as an initial location “Pγ1” is in the upper sub-area (i.e., the (X, Y) coordinates of “Pγ1” is included in the upper sub-area), the sub-area identifier 61 identifies the initial location included in the upper sub-area (“YES” of step S62).

As shown by the line “β” in FIG. 15, for instance, as an initial location “Pβ1” is in the lower sub-area (i.e., the (X, Y) coordinates of “Pβ1” is included in the lower sub-area), the sub-area identifier 61 does not identify the initial location included in the upper sub-area (“NO” of step S62). As shown by the line “δ” in FIG. 15, for instance, as an initial location “Pδ1” is in the lower sub-area (i.e., the (X, Y) coordinates of “Pδ1” is included in the lower sub-area), the sub-area identifier 61 does not identify the initial location included in the upper sub-area (“NO” of step S62).

Upon identifying the initial location included in the upper sub-area (“YES” of step 62), the sub-area identifier 61 identifies whether the final location is in the upper sub-area based on the (X, Y) coordinates included in the final location data (step S63).

As shown by the line “α” in FIG. 15, for instance, as a final location “Pαn” is in the upper sub-area (i.e., the (X, Y) coordinates of “Pαn” is included in the upper sub-area), the sub-area identifier 61 identifies the final location included in the upper sub-area (“YES” of step S63). As shown by the line “γ” in FIG. 15, for instance, as a final location “Pγn” is in the lower sub-area (i.e., the (X, Y) coordinates of “Pγn” is included in the lower sub-area), the sub-area identifier 61 identifies the final location not included in the upper sub-area (“NO” of step S63).

Upon identifying the final location included in the upper sub-area (“YES” of step S63), the sub-area identifier 61 provides the speed selector 57 with a result of identification of the initial location and the final location both included in the upper sub-area.

The speed selector 57 identifies the initial location and the final location both included in the upper sub-area based on the result of identification provided by the sub-area identifier 61. The speed selector 57 then selects the scroll speed “A” (step S64). The speed selector 57 provides the scroll controller 54 with selected speed data of “A”.

Upon identifying the final location not included in the upper sub-area (“NO” of step S63), the sub-area identifier 61 provides the speed selector 57 with a result of identification of the initial location included in the upper sub-area and the final location not included in the upper sub-area.

The speed selector 57 identifies the initial location included in the upper sub-area and the final location not included in the upper sub-area based on the result of identification provided by the sub-area identifier 61. The speed selector 57 then selects the scroll speed “C” (step S65). The speed selector 57 provides the scroll controller 54 with selected speed data of “C”.

Upon identifying the initial location not included in the upper sub-area (“NO” of step 62), the sub-area identifier 61 identifies whether the final location is in the upper sub-area based on the (X, Y) coordinates included in the final location data (step S66).

As shown by the line “β” in FIG. 15, for instance, as a final location “Pβn” is in the lower sub-area (i.e., the (X, Y) coordinates of “Pβn” is included in the lower sub-area), the sub-area identifier 61 identifies the final location included in the lower sub-area (“NO” of step S66). As shown by the line “δ” in FIG. 15, for instance, as a final location “Pδn” is in the upper sub-area (i.e., the (X, Y) coordinates of the point “Pδn” is included in the upper sub-area), the sub-area identifier 61 identifies the final location included in the upper sub-area (“YES” of step S66).

Upon identifying the final location included in the upper sub-area (“YES” of step S66), the sub-area identifier 61 provides the speed selector 57 with a result of identification of the initial location not included in the upper sub-area and the final location included in the upper sub-area.

The speed selector 57 identifies the initial location not included in the upper sub-area and the final location included in the upper sub-area, based on the result of identification provided by the sub-area identifier 61. The speed selector 57 then selects the scroll speed “D” (step S67). The speed selector 57 provides the scroll controller 54 with selected speed data of “D”.

Upon identifying the final location not included in the upper sub-area (“NO” of step S66), the sub-area identifier 61 provides the speed selector 57 with a result of identification of the initial location or the final location neither included in the upper sub-area.

The speed selector 57 identifies the initial location or the final location neither included in the upper sub-area based on the result of identification provided by the sub-area identifier 61. The speed selector 57 then selects the scroll speed “B” (step S68). The speed selector 57 provides the scroll controller 54 with selected speed data of “B”.

As the flow of operation goes ahead, the scroll controller 54 controls operation of scrolling a screen displayed on the main LCD 17 in the selected scroll condition (step S69). If the upward scroll direction and the scroll speed “A” are selected, for instance, the screen may be scrolled upwards at the scroll speed “A”.

According to the third method described above, the tactile sensor 20 fit in place on the mobile phone 1 may sequentially detect the object (e.g., a finger or a stylus) so that the initial and final locations of the object are located on the sensing surface of the tactile sensor 20. The scroll direction may be selected based on the location data of the initial and final locations. The scroll speed may be selected depending on in which sub-area of the sensing surface the initial and final locations are located.

The mobile phone 1 may thereby enable quick and easy selection of a preferred scroll condition in a visual manner despite of a limited resource of the mobile phone 1 so that a screen displayed on the main LCD 17 may be scrolled in the preferred scroll condition. The mobile phone 1 may thereby be comfortably operated by using the third method. The sensing surface of the tactile sensor 20 may be divided into more than two sub-areas for convenience.

Recall that the mobile phone 1 selects a scroll speed, by the first method, based on an estimated distance between the initial location and the final location of an object detected by the tactile sensor 20. Instead, the mobile phone 1 may estimate pressure of the object applied to the sensing surface of the tactile sensor 20, and may select a scroll speed based on the estimated pressure.

Such a method by using pressure applied to the tactile sensor 20 will be described as a fourth method for selecting a scroll condition applicable to the mobile phone 1, one of data processing apparatus of the embodiment of the present invention, with reference to FIGS. 16-18.

The fourth method may be effective for quick and easy selection of a preferred scroll condition in a case where an area of the sensing surface of the tactile sensor 20 is so small that the object may not move enough on the sensing surface.

FIG. 16 shows a concept of the fourth method by using a simplified drawing of the mobile phone 1 like FIG. 4 of the first method. Each portion of the mobile phone 1 shown in FIG. 16 is a same as the corresponding one given the same reference numeral shown in FIG. 1, and its explanation is omitted.

FIG. 16 illustrates a case where an object is sequentially detected between an initial location “P1” and a final location “Pn” on the tactile sensor 20. That is, the object is detected first at “P1”, keeps in contact with and moves on the tactile sensor 20 from “P1” to “Pn”, and then leaves the tactile sensor 20 at “Pn”. Meanwhile, a pressure value of the object applied to the tactile sensor 20 is assumed to be greater than a given threshold.

FIG. 16 illustrates another case where an object is sequentially detected between an initial location “Q1” and a final location “Qn” on the tactile sensor 20. That is, the object is detected first at “Q1”, keeps in contact with and moves on the tactile sensor 20 from “Q1” to “Qn”, and then leaves the tactile sensor 20 at “Qn”. Meanwhile, a pressure value of the object applied to the tactile sensor 20 is assumed to be no greater than the given threshold.

The mobile phone 1 adopting the fourth method is configured to select a scroll direction depending on a direction in which a detected object has moved on the tactile sensor 20, and configured to select a scroll speed depending on a pressure value of the object applied to the tactile sensor 20.

In the above case where the object moves from “P1” to “Pn” the mobile phone 1 selects a downward scroll direction as the object moves downwards, and selects a fast scroll speed given a value “A” as the pressure value is greater than the given threshold. In the above case where the object moves from “Q1” to “Qn”, the mobile phone 1 selects a downward scroll direction as the object moves downwards, and selects a slow scroll speed given a value “B” as the pressure value is no greater than the given threshold.

The mobile phone 1 may thereby enable quick and easy selection of a preferred scroll condition even in a case where an area of the sensing surface of the tactile sensor 20 is so small that the object may not move enough on the sensing surface.

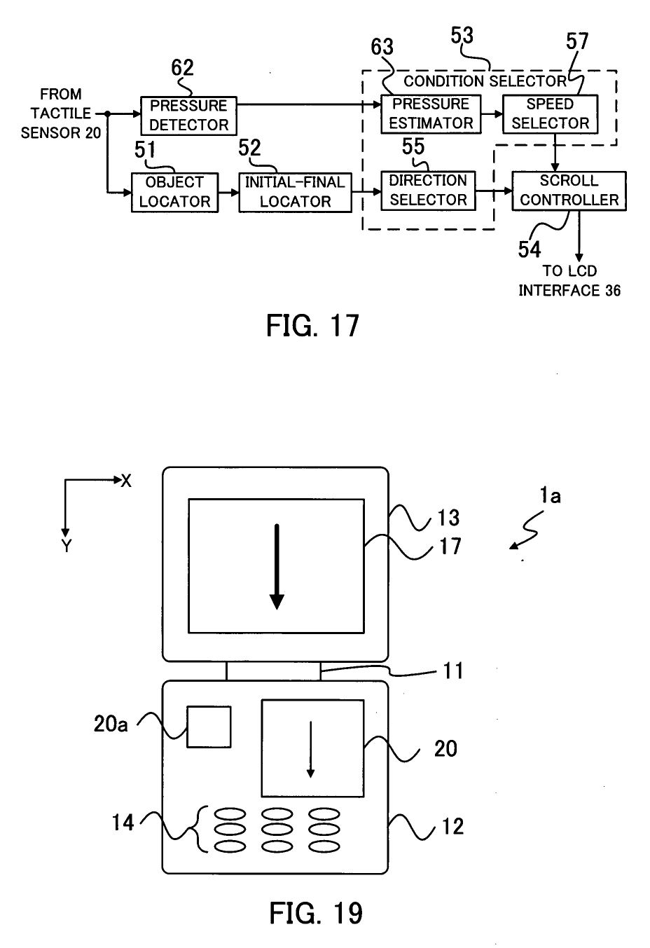

FIG. 17 is a functional block diagram of the mobile phone 1, one of data processing apparatus of the embodiment of the present invention, adopting the fourth method. Each of functional blocks shown in FIG. 17 may be implemented by at least one of the portions of the mobile phone 1 shown in FIG. 3.

In FIG. 17, shown is a pressure detector 62 which may be implemented by the main controller 31. The pressure detector 62 may sequentially detect pressure applied to the sensing surface of the tactile sensor 20, and may provide a condition selector 53 with detected pressure data.

The condition selector 53 may be implemented by the main controller 31 and includes three functional blocks, the direction selector 55, the speed selector 57 and a pressure estimator 63. The direction selector 55 and the speed selector 57 are configured to select a scroll direction and a scroll speed for scrolling a screen on the main LCD 17, respectively. The pressure estimator 63 is configured to estimate a pressure value applied to the sensing surface of the tactile sensor 20 between the initial location and the final location of the object.

The pressure estimator 63 may be implemented by the main controller 31. The pressure estimator 63 may estimate a maximum value of the pressure applied to the sensing surface of the tactile sensor 20 between the initial location and the final location of the object, based on the detected pressure data provided by the pressure detector 62. The pressure estimator 63 may provide the speed selector 57 with estimated pressure data.

The speed selector 57 may determine whether the estimated value of the pressure provided by the pressure estimator 63 is greater than a given threshold. Upon determining that the estimated value of the pressure is greater than the given threshold, the speed selector 57 selects the fast scroll speed “A” as shown in FIG. 16. Upon determining that the estimated value of the pressure is no greater than the given threshold, the speed selector 57 selects the slow scroll speed “B” as shown in FIG. 16.

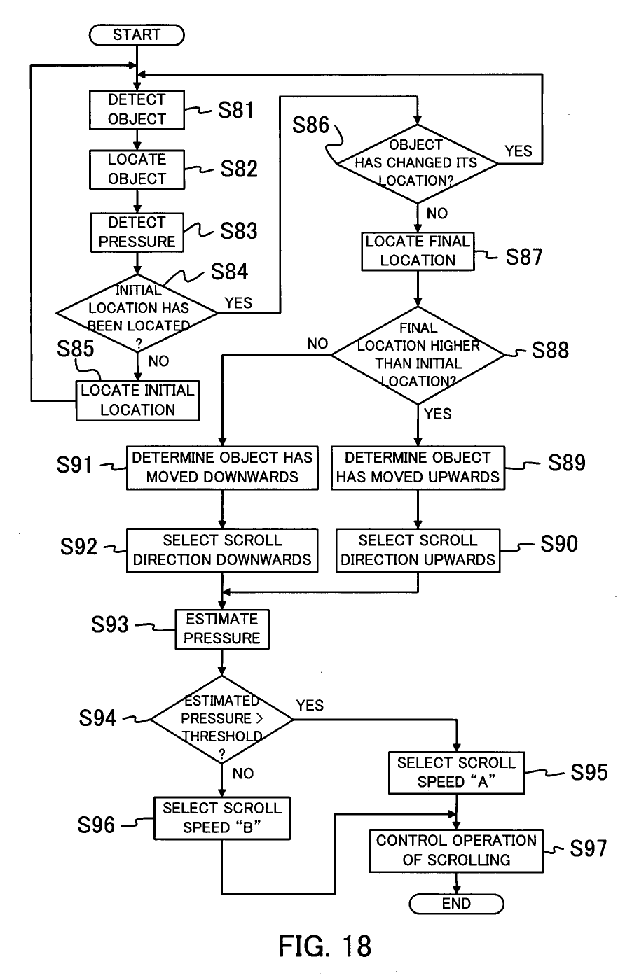

A flow of operation of the fourth method for selecting a scroll condition of the embodiment of the present invention will be described with reference to FIG. 18, a flow chart of the fourth method. Note that each of steps S81, S82, S84-S92 and S97 in FIG. 18 is a same as each of the steps S1-S11 and S16 in FIG. 6, respectively, and its explanation is omitted.

The pressure detector 62 sequentially detects pressure applied by an object to the sensing surface of the tactile sensor 20, and provides the pressure estimator 63 with detected pressure data (step S83).

The flow of operation then goes to the step S84 and its following steps. The pressure detector 62 may sequentially detect the pressure applied by the object that moves from an initial location to a final location, both located on the sensing surface of the tactile sensor 20.

The pressure estimator 63 estimates a maximum value of the pressure applied to the sensing surface of the tactile sensor 20 between the initial location and the final location of the object, based on the detected pressure data provided by the pressure detector 62 (step S93). The pressure estimator 63 provides the speed selector 57 with the estimated pressure data.

The speed selector 57 determines whether the estimated value of the pressure provided by the pressure estimator 63 is greater than a given threshold. Upon determining that the estimated value of the pressure is greater than the given threshold (“YES” of step S94), the speed selector 57 selects the fast scroll speed “A” (step S95). Upon determining that the estimated value of the pressure is no greater than the given threshold (“NO” of step S94), the speed selector 57 selects the slow scroll speed “B” (step S96).

According to the fourth method described above, the tactile sensor 20 fit in place on the mobile phone 1 may sequentially detect the object (e.g., a finger or a stylus) so that the initial and final locations of the object are located on the sensing surface of the tactile sensor 20. The scroll direction may be selected based on the location data of the initial and final locations. The scroll speed may be selected depending on a pressure value applied by the object to the tactile sensor 20.

The mobile phone 1 may thereby enable quick and easy selection of a preferred scroll condition even in a case where an area of the sensing surface of the tactile sensor 20 is so small that the object may not move enough on the tactile sensor 20. The mobile phone 1 may thereby be comfortably operated by using the fourth method.

The mobile phone 1 may be configured to have no less than two tactile sensors and to select a scroll speed depending on which of the tactile sensors has detected an object. In a case where the mobile phone 1 has two tactile sensors, for instance, the scroll speed may be selected depending on which one of the two tactile sensors has detected the object.

Such a method by using no less than two tactile sensors will be described as a fifth method for selecting a scroll condition applicable to the mobile phone 1, one of data processing apparatus of the embodiment of the present invention, with reference to FIGS. 19-21.

FIG. 19 shows a concept of the fifth method by using a simplified drawing of the mobile phone 1 like FIG. 4 of the first method. In FIG. 19, the mobile phone 1 has an extra tactile sensor 20a in addition to the tactile sensor 20. Other than the tactile sensor 20a, each portion of the mobile phone 1 shown in FIG. 19 is a same as the corresponding one given the same reference numeral shown in FIG. 1, and its explanation is omitted.

The mobile phone 1 adopting the fifth method is configured to select a scroll direction depending on a direction in which a detected object has moved on the tactile sensor 20, and configured to select a scroll speed depending on by which of the two tactile sensors an object is detected first.

The mobile phone 1 is configured to select a fast scroll speed given a value “A” if an object is detected first by the tactile sensor 20, and configured to select a slow scroll speed given a value “B” if an object is detected first by the tactile sensor 20a. The mobile phone 1a thereby may enable quick and easy selection of a preferred scroll speed for scrolling a screen on the main LCD 17.

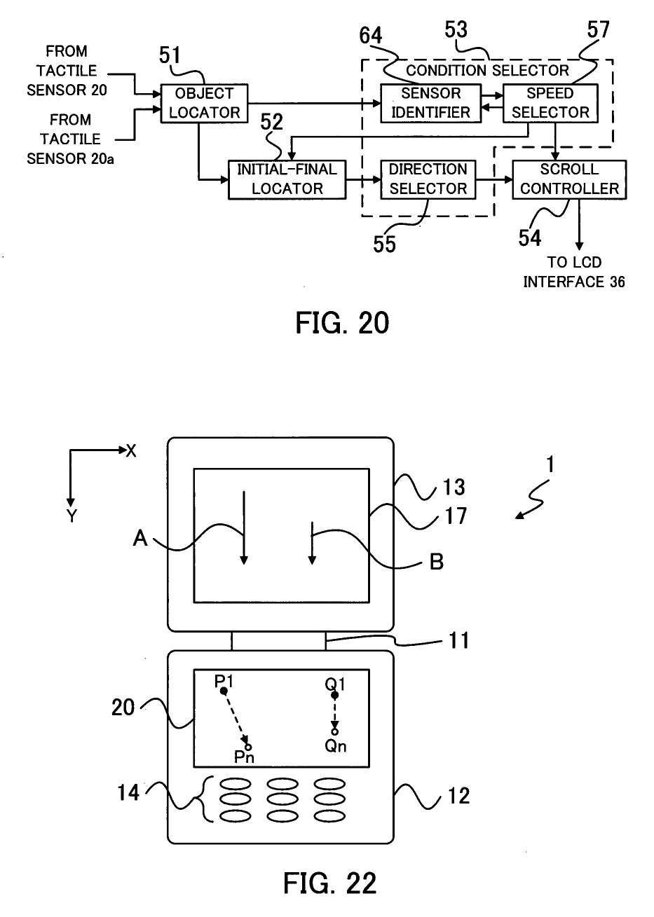

FIG. 20 is a functional block diagram of the mobile phone 1, one of data processing apparatus of the embodiment of the present invention, adopting the fifth method. Each of functional blocks shown in FIG. 20 may be implemented by at least one of the portions of the mobile phone 1 shown in FIG. 3. Each of the functional blocks which is a same as the corresponding one shown in FIG. 5 is given the same reference numeral, and its explanation is omitted.

In FIG. 20, the condition selector 53 includes three functional blocks, the direction selector 55, the speed selector 57 and a sensor identifier 64. The direction selector 55 and the speed selector 57 are configured to select a scroll direction and a scroll speed for scrolling a screen on the main LCD 17, respectively. The sensor identifier 64 may identify by which tactile sensor, 20 or 20a, an object is detected.

The sensor identifier 64 may be implemented by the main controller 31 shown in FIG. 3. The sensor identifier 64 may identify the tactile sensor based on from which tactile sensor, either 20 or 20a, a signal of detection has come. In a case where sensing surfaces of the tactile sensors 20 and 20a has a single (X, Y) coordinate system in common, the sensor identifier 64 may identify the tactile sensor based on (X, Y) coordinates of the object provided by the object locator 51. The sensor identifier 64 may provide the speed selector 57 with a result of identification.

The speed selector 57 may identify the tactile sensor by which the object is detected, either 20 or 20a, based on the result of identification provided by the sensor identifier 64. Upon identifying that the object is detected by the tactile sensor 20, the speed selector 57 selects the fast scroll speed “A”. Upon identifying that the object is detected by the tactile sensor 20a, the speed selector 57 selects the slow scroll speed “B”.

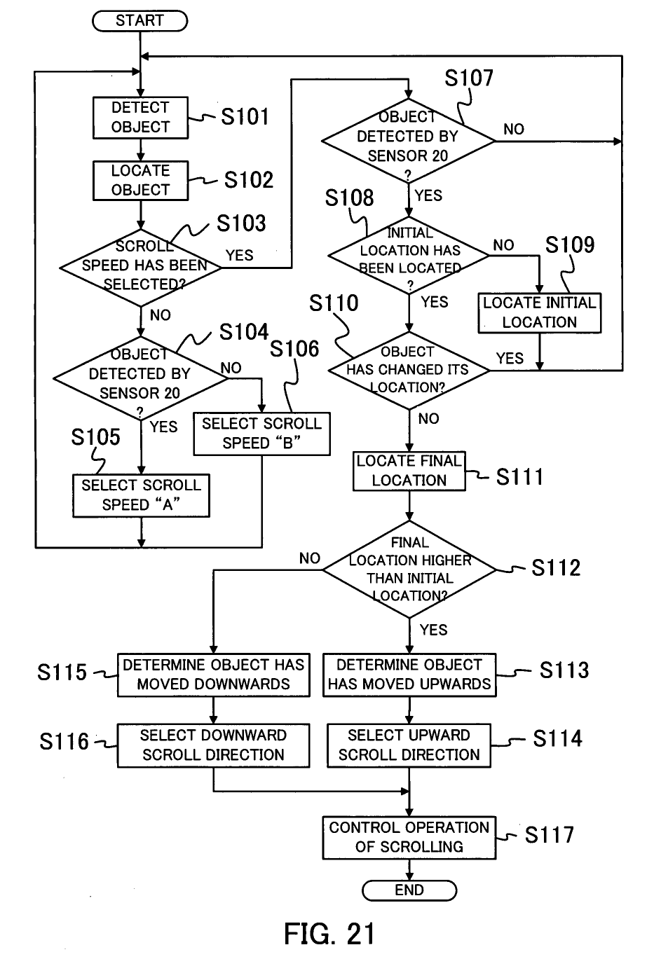

A flow of operation of the fifth method for selecting a scroll condition of the embodiment of the present invention will be described with reference to FIG. 21, a flow chart of the fifth method. Note that each of steps S101, S102, S108-S117 is a same as each of the steps S1-S11 and S16 shown in FIG. 6, and its explanation is omitted.

After the flow of operation starts and an object like a finger is detected and located by one of the tactile sensors 20 and 20a at the steps S101-S102, the sensor identifier 64 receives a notice from the speed selector 57 of whether a scroll speed has been selected (step S103).

Upon noticing that a scroll speed has not been selected yet (“NO” of the step S103), the sensor identifier 64 determines whether the object is detected by the tactile sensor 20 based on object location data provided by the object locator 51 (step S104).

Upon determining that the object is detected by the tactile sensor 20 at the step S104, the sensor identifier 64 provides the speed selector 57 with a result of determination that the object is detected by the tactile sensor 20.

The speed selector 57 recognizes that the object is detected by the tactile sensor 20 based on the result of determination provided by the sensor identifier 64. The speed selector 57 then selects the scroll speed “A” (step S105), and provides the scroll controller 54 with selected speed data of “A”.

Upon determining that the object is detected not by the tactile sensor 20 at the step S104, the sensor identifier 64 provides the speed selector 57 with a result of determination that the object is detected by the tactile sensor 20a.

The speed selector 57 recognizes that the object is detected by the tactile sensor 20a based on the result of determination provided by the sensor identifier 64. The speed selector 57 then selects the scroll speed “B” (step S106), and provides the scroll controller 54 with selected speed data of “B”.

After a scroll speed is selected at the steps S105 and S106, the flow of operation goes back to and repeats the steps S101-S103, and then goes ahead so that a scroll direction is selected. At this stage, the object has to be detected by the tactile sensor 20, not by the tactile sensor 20a. In a case where the tactile sensor 20 detects the object first so that the scroll speed “A” is selected, the object should remain and move on the tactile sensor 20.

Upon noticing that a scroll speed has been selected (“YES” of step S103), the initial-final locator 52 determines whether the object is detected by the tactile sensor 20 (step S107). Upon determining that the object is detected by the tactile sensor 20 (“YES” of step 107) and that an initial location of the object has not been located yet (“NO” of step S108), the initial-final locator 52 locates an initial location of the object (step S109).

If it is determined that the object is not detected by the tactile sensor 20 (“NO” of step 107), the flow of operation goes back to the step S101 and repeats the steps following the step S101 described above.

If the scroll speed has been selected (“YES” of the step S103), the flow of operation goes to the step S107 as described above while skipping the steps S104-S106. The condition selector 53 may then locate initial and final locations of the object and select a scroll direction while the scroll speed has already been selected (steps S108-S116).

According to the fifth method described above, the mobile phone 1 having an extra tactile sensor 20a fit in place thereon may select a scroll speed depending on by which of the two tactile sensors 20 and 20a an object is detected first. The tactile sensor 20 may sequentially detect the object so that the initial and final locations of the object are located on the sensing surface of the tactile sensor 20. The scroll direction may be selected based on the initial location data and the final location data.

The mobile phone 1a may thereby enable quick and easy selection of a preferred scroll condition despite of a limited resource of the mobile phone 1a so that a screen displayed on the main LCD 17 may be scrolled in the preferred scroll condition. The mobile phone 1a may thereby be comfortably operated by using the fifth method.

The mobile phone 1 may use, e.g., the first soft key 14c and the second soft key 14d for selecting a scroll speed, instead of the tactile sensors 20 and 20a. The mobile phone 1 may have no less than three tactile sensors so as to enable selection of a preferred scroll condition in a quicker, easier and more precise manner.

The mobile phone 1 may select a scroll speed depending on how many times an object is detected by the tactile sensor 20a. That is, e.g., if the object is detected by the tactile sensor 20a twice, the mobile phone 1 selects a scroll speed twice as fast as the scroll speed “B”. The mobile phone 1 may thereby enable selection of a preferred scroll condition despite of a limited resource of the mobile phone 1a in a quicker and easier manner.

The mobile phone 1 of the previous embodiments may be configured to select a scroll condition after the tactile sensor 20, fit in place on the mobile phone 1, detects an object not sequentially but separately in time.

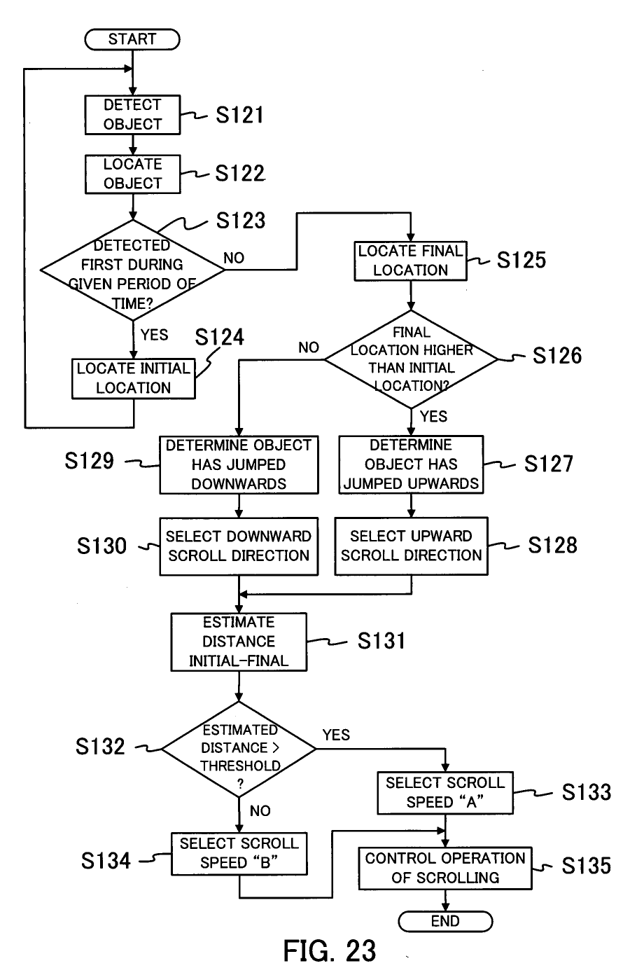

Such a method based on not sequential but separate detection of an object will be described as a sixth method for selecting a scroll condition applicable to the mobile phone 1, one of data processing apparatus of the embodiment of the present invention, with reference to FIGS. 22-23.

FIG. 22 shows a concept of the sixth method by using a simplified drawing of the mobile phone 1 like FIG. 4 of the first method. Each portion of the mobile phone 1 shown in FIG. 22 is a same as the corresponding one given the same reference numeral shown in FIG. 1, and its explanation is omitted.

FIG. 22 illustrates a case where an object is detected twice, separately in time, on the sensing surface of the tactile sensor 20. The object is detected first at an initial location “P1”, then jumps to and is detected next at a final location “Pn”. A distance between “P1” and “Pn” is assumed to be greater than a given threshold.

FIG. 22 illustrates another case where an object is detected twice, separately in time, on the sensing surface of the tactile sensor 20. The object is detected first at an initial location “Q1”, then jumps to and is detected next at a final location “Qn”. A distance between “Q1” and “Qn” is assumed to be no greater than the given threshold.

The mobile phone 1 adopting the sixth method is configured to select a scroll direction depending on a direction in which a detected object has jumped on the tactile sensor 20, and configured to select a scroll speed depending on a distance between initial and final locations of the object on the tactile sensor 20.

In the above case where the object jumps from “P1” to “Pn”, the mobile phone 1 selects a downward scroll direction as the object jumps downwards, and selects a fast scroll speed given a value “A” as the distance between “P1” and “Pn” is greater than the given threshold. In the above case where the object jumps from “Q1” to “Qn”, the mobile phone 1 selects a downward scroll direction as the object jumps downwards, and selects a slow scroll speed given a value “B” as the distance between “Q1” and “Qn” is no greater than the given threshold.

The mobile phone 1 may thereby select a scroll condition for scrolling a screen on the main LCD 17 after the tactile sensor 20 detects an object (e.g., a finger or a stylus) separately in time without a move of the object on the tactile sensor 20. The screen may be scrolled on the main LCD 17 in the selected scroll condition.

The mobile phone 1 adopting the sixth method may include functional blocks which basically equal those of the first method shown in FIG. 5, and their explanations are omitted.

A flow of operation of the sixth method for selecting a scroll condition of the embodiment of the present invention will be described with reference to FIG. 23, a flow chart of the sixth method. Note that each of steps S126-S135 in FIG. 23 is a same as each of the steps S8-S17 in FIG. 6, and its explanation is omitted.

The tactile sensor 20 detects an object (e.g., a finger or a stylus) on its sensing surface so as to produce a signal of detection containing information about a location of the object represented by, e.g., (X, Y) coordinates shown in FIG. 7, and containing information about how much pressure is applied to the tactile sensor 20 at the location of the object (step S121). The tactile sensor 20 provides the object locator 51 with the signal of detection.

Upon receiving the signal of detection from the tactile sensor 20, the object locator 51 provides the initial-final locator 52 with object location data (step S122).

Upon receiving the object location data from the object locator 51, the initial-final locator 52 determines whether the object is detected first during a given period of time based on the object location data (step S123).

Upon determining that the object is detected first during the given period of time (“YES” of step S123), the initial-final locator 52 locates an initial location of the object based on the location data (step S124). The initial-final locator 52 provides the direction selector 55 and the distance estimator 56, both included in the condition selector 53, with initial location data. The flow of operation then goes back to the step S121, and repeats the steps following the step 121 described above.

Upon determining that the object is detected no less than twice during the given period of time (“NO” of step S123), the initial-final locator 52 locates a final location of the object based on the location data (step S125). The initial-final locator 52 provides the direction selector 55 and the distance estimator 56, both included in the condition selector 53, with final location data.

The flow of operation goes to following steps S126-S135 which are almost same as the steps S7-S16 shown in FIG. 6, and the scroll controller 54 controls the LCD interface 36 so that a screen displayed on the main LCD 17 may be scrolled according to the selected scroll direction and speed. If the upward scroll direction and the fast scroll speed are selected, for instance, the screen may be scrolled upwards at the fast scroll speed “A”.

According to the sixth method described above, the tactile sensor 20 fit in place on the mobile phone 1 detects the object twice so that the initial and final locations of the object are located on the sensing surface of the tactile sensor 20. The mobile phone 1 may select a scroll direction based on the initial location data and the final location data, and may select a scroll speed based on a distance between the initial location and the final location.

The mobile phone 1 may thereby enable quick and easy selection of a preferred scroll condition not by moving the object on the tactile sensor 20 but by letting the object jump on the tactile sensor 20. The mobile phone 1 may scroll a screen displayed on the main LCD 17 in the preferred scroll condition.

The tactile sensor 20 may have a smaller size by using the sixth method than by using the previous methods so that a cost of the tactile sensor 20 may be reduced. As the tactile sensor 20 may be touched by the object less repeatedly or less continuously by using the sixth method than by using the previous methods, the mobile phone 1 may enjoy a longer lifetime of the tactile sensor 20. The mobile phone 1 may thereby be comfortably operated.

The mobile phone 1 may be configured, after selecting a scroll condition, to hold the selected scroll condition, e.g., in the storage device 47. The mobile phone 1 may be configured to recall the held scroll condition if the tactile sensor 20 detects an object (e.g., a finger or a stylus) and configured to scroll a screen displayed on the main LCD 17 according to the recalled scroll condition.

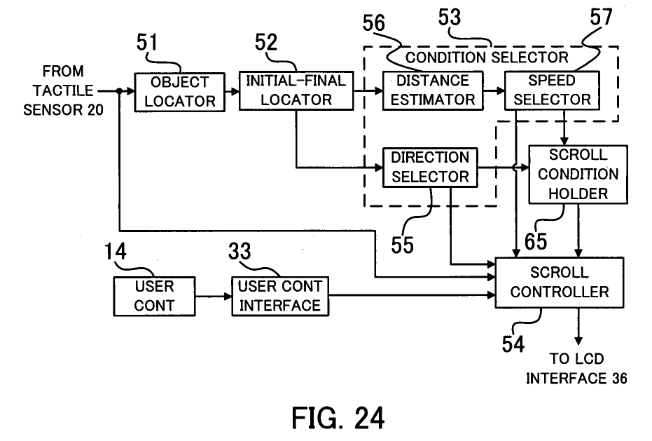

Such a method by using a held scroll condition will be described as a seventh method for selecting a scroll condition applicable to the mobile phone 1, one of data processing apparatus of the embodiment of the present invention, with reference to FIGS. 24-26.

FIG. 24 is a functional block diagram of the mobile phone 1, one of data processing apparatus of the embodiment of the present invention, adopting the seventh method. Each of the functional blocks which is a same as the corresponding one shown in FIG. 5 is given the same reference numeral, and its explanation is omitted.

In FIG. 24, shown is a scroll condition holder 65 as one of the functional blocks of the mobile phone 1. The scroll condition holder 65 may be implemented by, e.g., the storage device 47. The scroll condition holder 65 may hold therein selected direction data and selected speed data provided by the direction selector 55 and the speed selector 57, respectively.

In FIG. 24, shown are the set of user controls 14 and the user control interface 33, as the scroll controller 54 may be controlled according to control operation done on the set of user controls 14 by using the seventh method. The user control interface 33 transfers various instructions and information entered from the set of user controls 14 to each portion of the mobile phone 1.

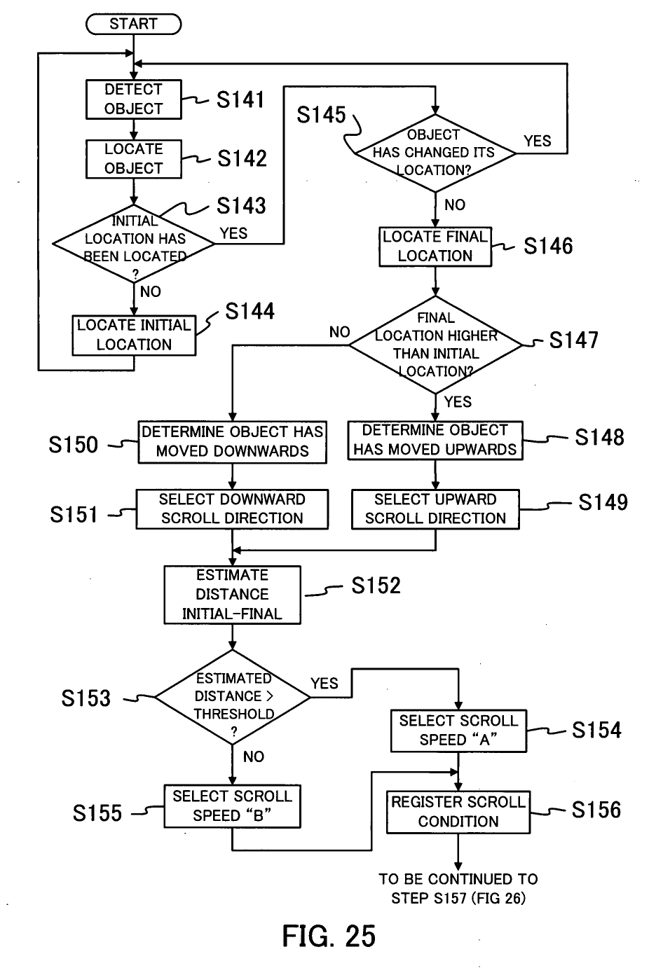

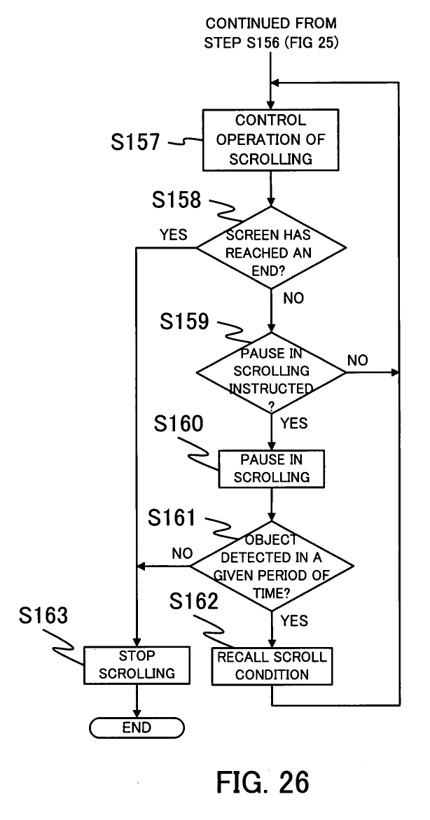

A flow of operation of the seventh method for selecting a scroll condition of the embodiment of the present invention will be described with reference to FIGS. 25-26 presenting a flow chart of the seventh method in series. Note that each of steps S141-S155 in FIG. 25 and S157 in FIG. 26 is a same as each of the steps S1-S16 in FIG. 6, and its explanation is omitted.

The direction selector 55 provides the scroll condition holder 65 with selected direction data so as to hold the selected direction data in the scroll condition holder 65. The speed selector 57 provides the scroll condition holder 65 with selected speed data so as to hold the selected speed data in the scroll condition holder 65 (step S156).

The scroll controller 54 determines whether a screen displayed on the main LCD 17 has reached an upper end or a lower end thereof after being scrolled (step S158).

Upon determining that the screen has reached neither the upper end nor the lower end (“NO” of step S158), the scroll controller 54 determines whether a pause in scrolling is instructed from the set of user controls 14 and through the user control interface 33 (step S159).

Upon determining that a pause in scrolling is instructed at the step S159, the scroll controller 54 controls the LCD interface 36 so as to give a pause in scrolling a screen displayed on the main LCD 17 (step S160).

After the pause in scrolling, the scroll controller 54 determines whether an object is detected by the tactile sensor 20 in a given period of time (e.g., 30 seconds) (step S161).

Upon determining that an object is detected by the tactile sensor 20 in the given period of time after the pause in scrolling (“YES” of step S161), the scroll controller 54 recalls the selected scroll direction and the selected scroll speed held in the scroll condition holder 65 (step S162).

The flow of operation then goes back to the step S157, and repeats the steps following the step S157 described above. The scroll controller 54 thus controls operation of scrolling a screen displayed on the main LCD 17 according to the scroll direction and the scroll speed recalled from the scroll condition holder 65. The scroll controller 54 thereby does not need reentering a scroll condition in order to resume scrolling in the given period of time after the pause in scrolling.

Upon determining that no object is detected by the tactile sensor 20 in the given period of time after the pause in scrolling (“NO” of step S161), the scroll controller 54 stops scrolling (step S163).

Upon determining that the screen has reached the upper end or the lower end thereof (“YES” of step S158), the scroll controller 54 stops scrolling (step S163).

The mobile phone 1 may need to resume scrolling after accidentally giving a pause in scrolling. In such a case, by using the seventh method, the mobile phone 1 does not need reentering a scroll condition but may control operation of scrolling according to the scroll condition already selected and held therein. The mobile phone 1 may thereby enable quick and easy selection of a preferred scroll condition. The mobile phone 1 may control operation of scrolling in the preferred manner, and may be comfortably operated.

The tactile sensor 20 formed by highly integrated pressure sensors of the mobile phone 1, adopting one of the first to seventh methods described above, may be replaced by another kind of tactile sensors capable of detecting an object, e.g., an electrostatic sensor usable for an electrostatic touchpad.

The condition selector 53 of the mobile phone 1, adopting one of the first to seventh methods described above, may be configured to select a scroll condition after an object moves or jumps on the tactile sensor 20. The condition selector 53 may be configured, instead, to select a scroll condition in real time while an object is moving or jumping on the tactile sensor 20.

The present invention may be applied not only to a mobile phone having a built-in camera, but to a mobile phone without a camera, a personal digital assistant (PDA), a personal computer and so on.

The flow of operation of each of the first to seventh methods described above may be implemented not only by software but by hardware. Each of the steps shown in the flow charts referred to above may be processed not only in series but also in parallel or independently.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A data processing apparatus capable of detecting an object being in contact with a portion of the data processing apparatus, comprising:
a display configured to display a screen;
a tactile sensor having a sensing surface, the tactile sensor configured to detect the object, the tactile sensor configured to locate the object on the sensing surface; and
a controller coupled to the display and the tactile sensor,
the controller configured to locate an initial location of the object on the sensing surface upon the object starting being detected, the controller configured to locate a final location of the object on the sensing surface upon the object ending being detected;
the controller configured to select a scroll direction depending on a direction from the initial location to the final location,
the controller configured to select a scroll speed, and
the controller configured to scroll the screen on the display in the scroll direction at the scroll speed.

2. The data processing apparatus of claim 1, wherein the controller is further configured to select the scroll speed depending on a distance between the first location and the final location.

3. The data processing apparatus of claim 1, wherein the controller is further configured to estimate a moving speed of the object on the sensing surface, and the controller is further configured to select the scroll speed depending on the moving speed.

4. The data processing apparatus of claim 1, wherein the tactile sensor is further configured so that the sensing surface is divided into a plurality of sub-areas, and the controller is further configured to select the scroll speed depending on which of the sub-areas the initial location and the final location each belong to.

5. The data processing apparatus of claim 1, wherein the tactile sensor is further configured to estimate a value of pressure applied by the object to the sensing surface, and the controller is further configured to select the scroll speed on the display depending on the value of the pressure.

6. The data processing apparatus of claim 1, further comprising an extra tactile sensor configured to detect the object, wherein the controller is further configured to select the scroll speed depending on which one of the tactile sensor and the extra tactile sensor the object is detected by.

7. The data processing apparatus of claim 1, wherein
the controller is further configured to locate the initial location of the object on the sensing surface upon the object being detected by the tactile sensor first in a given period of time,
the controller is further configured to locate the final location of the object on the sensing surface upon the object being detected by the tactile sensor next in the given period of time, and
the controller is further configured to select the scroll speed depending on a distance between the first location and the final location.

8. The data processing apparatus of claim 1, further comprising a storage device and an operation input device, the storage device configured to hold data of the scroll direction and the scroll speed, wherein
the controller is further configured to let the storage device hold the data of the scroll direction and the scroll speed,
the controller is further configured to give a pause in scrolling upon the pause being instructed through the operation input device,
the controller is further configured to recall the data of the scroll direction and the scroll speed out of the storage device for scrolling the screen upon the tactile sensor detecting one of the object and another object after the pause.

9. A method for selecting a condition for scrolling a screen displayed by a data processing apparatus, comprising:
detecting an object being in contact with a sensing surface of a tactile sensor of the data processing apparatus;
locating an initial location of the object on the sensing surface upon the object starting being detected;
locating a final location of the object on the sensing surface upon the object ending being detected;
selecting a scroll direction depending on a direction from the initial location to the final location;
selecting a scroll speed; and
scrolling the screen on the display in the scroll direction at the scroll speed.

10. The method of claim 9, wherein the scroll speed is selected depending on a distance between the first location and the final location.

11. The method of claim 9, further comprising estimating a moving speed of the object on the sensing surface, wherein the scroll speed is selected depending on the moving speed.

12. The method of claim 9, wherein
the tactile sensor is configured so that the sensing surface is divided into a plurality of sub-areas, and
the scroll speed is selected depending on which of the sub-areas the initial location and the final location each belong to.

13. The method of claim 9, further comprising estimating a value of pressure applied by the object to the sensing surface, wherein the scroll speed is selected depending on the value of the pressure.

14. The method of claim 9, wherein the data processing apparatus includes an extra tactile sensor, and the scroll speed is selected depending on which one of the tactile sensor and the extra tactile sensor the object is detected by.

15. The method of claim 9, wherein
the initial location of the object is located on the sensing surface upon the object being detected by the tactile sensor first in a given period of time,
the final location of the object is located on the sensing surface upon the object being detected by the tactile sensor next in the given period of time, and
the scroll speed is selected depending on a distance between the first location and the final location.

16. The method of claim 9, further comprising
holding data of the scroll direction and the scroll speed,
giving a pause in scrolling upon being instructed to give the pause, and
recalling the data of the scroll direction and the scroll speed upon detecting one of the object and another object after the pause.
